(19) United States
(12) Patent Application Publication
(10) Pub. No.: US 2015/0110990 A1
(43) Pub. Date: Apr. 23, 2015

(54) Methods and Apparatus Providing A Substrate and Protective Coating Thereon

(71) Applicant: CORNING INCORPORATED, CORNING, NY (US)

(72) Inventors: Hsin-Chieh Chou, San Mateo, CA (US); Donald Arthur Clark, Corning, NY (US); Sinue Gomez, Corning, NY (US); Kimberly Michelle Keegan, Corning, NY (US); Arthur Winston Martin, Horseheads, NY (US); James Robert Matthews, Painted Post, NY (US); Prakash Chandra Panda, Ithaca, NY (US); Paul John Shustack, Elmira, NY (US); Lu Zhang, Taipei (TW)

(21) Appl. No.: 14/516,685

(22) Filed: Oct. 17, 2014

Related U.S. Application Data
(60) Provisional application No. 61/895,550, filed on Oct. 25, 2013.
(60) Provisional application No. 61/892,731, filed on Oct. 18, 2013.

(51) Int. Cl. C03C 17/00; B05D 3/10; B05D 3/06

(52) U.S. Cl. CPC C03C 17/007; C03C 17/009; B05D 3/067; B05D 3/104; C03C 2217/478; C03C 2217/445; C03C 2217/78
USPC 428/76; 428/68; 428/192; 428/428; 428/331; 428/425.6; 428/417; 428/335; 427/508; 427/309; 427/299; 427/387; 427/386

(57) ABSTRACT

Methods and apparatus are provide for: a glass substrate having first and second opposing surfaces, and a plurality of edge surfaces extending transversely between the first and second opposing surfaces; a layer disposed on, and adhered to, at least one of the first, second, and edge surfaces of the substrate, where the layer includes: (i) one of an oligomer and resin; (ii) a monomer; and (iii) nanometer-sized silica particles of at least about 2-50 weight percent.

### CROSS REFERENCE TO RELATED APPLICATION

This application claims the benefit of U.S. Provisional Patent Application No. 61/895,550, filed Oct. 25, 2013, and U.S. Provisional Patent Application No. 61/892,731, filed Oct. 18, 2013, the disclosures of are hereby incorporated by reference in their entirety.

### BACKGROUND

The present disclosure relates to methods and apparatus for achieving a functional coating on one or more surfaces and/or edges of a substrate, where the coating facilitates one or more performance characteristics, such as high indentation fracture threshold, low yellowness, and high transparency.

Glass may be extremely strong in a pristine, freshly drawn state; however, the strength of the glass rapidly deteriorates when surfaces and/or edges include flaws. Flaws can occur by way of contact between the glass with other objects, resulting in scratching, abrasion, and/or impact flaws.

Many consumer and commercial products employ a sheet of high-quality cover glass to, for example, protect critical devices within the product, provide a user interface for input and/or display, and/or many other functions. For example, mobile devices, such as smart phones, mp3 players, computer tablets, etc., often employ one or more sheets of high strength glass on the product to both protect the product and achieve the aforementioned user interface. In such applications, as well as others, the glass should be durable (e.g., scratch resistant and fracture resistant), transparent, and/or antireflective. Indeed, in a smart phone and/or tablet application, the cover glass is often the primary interface for user input and display, which means that the cover glass would exhibit high durability and high optical performance characteristics.

Among the evidence that the cover glass on a product may manifest exposure to harsh operating conditions, impact fractures and scratches are probably among the most common. Such evidence suggests that sharp contact, single-event damage is the primary source of visible defects on cover glass in mobile products. Once a significant fracture and/or scratch mars the cover glass of a user input/display element, the appearance of the product is degraded and the resultant increase in light scattering may cause significant reduction in brightness, clarity and contrast of images on the display. Significant fractures, cracks, and/or scratches can also affect the accuracy and reliability of touch sensitive displays. As severe flaws are both unsightly and can significantly affect product performance, they are often the leading complaint of customers, especially for mobile devices such as smart phones and/or tablets.

Accordingly, there are needs in the art for new methods and apparatus for achieving functional coatings on substrates, especially glass substrates.

### SUMMARY

In theory, pristine glass may exhibit very high strength characteristics, such as about 14 GPa; however, in practice, typical strength values are in the 70-100 MPa range. Consequently, glass substrates are susceptible to damage by mechanical contact, impact, scratching, abrasion, etc. The resultant flaws on a major surface, edge, and/or interface between the two makes the glass substrate vulnerable to subsequent flaw propagation (or worsening) and/or critical failure, such as breakage. The cutting of a large glass sheet into smaller glass sheets, and/or any number of finishing methods, often leave behind flaws or cracks in the glass, which may leave the edges of the glass particularly weak. For example, chemically strengthened glass, such as ion-exchanged glass, may exhibit significantly increased strength characteristics, including on major surfaces and edges, due to high levels of compressive stress imparted to the surfaces and edges during such ion exchange. When ion-exchanged glass is subsequently cut into smaller pieces, however, the resulting freshly exposed edges do not exhibit such compressive stress characteristics and are therefore of lower strength. Also, the cutting process itself may impart flaws onto the major surfaces, edges, and transitions.

It may be advantageous to impart one or more functional properties to a glass substrate by applying a coating to the substrate. The coating forms one or more layers on the glass substrate and may improve the characteristics of the uncoated glass, such as to reduce or eliminate propagation of flaws, breakage of the glass, and/or susceptibility of the glass to new flaws and resultant vulnerabilities therefrom. Some protective coatings for glass are known in the art, such as ultra-violet (UV) curable coatings, which provide a relatively fast and low-energy cure, a solvent-free composition, etc. However, there are still needs in the art for a coating that results in a particular performance characteristic (or combination of characteristics) when applied to a glass substrate, which has not heretofore been available in the art.

It has been discovered that combinations of certain coating compositions and/or types of glass result in a means to protect the glass from damage, but also to absorb impact energy and prevent existing and/or new flaws from propagating and possibly leading to breakage. Certain embodiments herein provide for a curable coating on a glass substrate to improve certain characteristics of the glass. Among such characteristics are: (i) high indentation fracture threshold and/or static indentation fracture resistance (a resistance to breakage by sharp impact, such as a diamond tip indenter, drop impact, tumble impact, pendulum impact, etc.); (ii) high edge impact resistance (a resistance to fracture at an interface of a major surface of the glass to an edge thereof, such as measured by a sliding drop test); (iii) high scratch and/or abrasion resistance (a resistance to flaws imposed by abrasive materials, such as sand blasts, sand paper, etc.); (iv) low yellowness (for example, low index according to ASTM D1925); and (v) high transparency (for example, optically clear, high transmission of visible, infra-red and ultra-violet light wavelengths, etc.).

It has been discovered that achieving some (or especially all) of these characteristics on certain types of glass is not possible using existing teachings in the art.

It has been discovered, however, that certain curable coating compositions applied to certain glass compositions achieve a previously unattainable combination of the above characteristics upon application to one or more of the major surfaces and/or one or more of the edges of the glass. The coating compositions may be based on urethane (meth)acrylate oligomer(s) or epoxy resins that are filled with nanometer-sized inorganic particles. For example, it has been discovered that for certain coating compositions and glass compositions: (i) the indentation fracture threshold on a coated edge of an alkali-free glass sample improved by a factor of at least about ten times (as compared to an uncoated edge) and the indentation fracture threshold on a coated surface of the alkali-free glass also improved by a factor of at least about ten times; (ii) the impact resistance of a coated surface to edge interface of the alkali-free glass sample improved by greater than eight times; (iii) the coated glass exhibited high scratch and abrasion resistance; (iv) the coated glass exhibited a yellowness of less than about 4.00 index using ASTM D1925; and (v) the coated glass exhibited high transparency in the visible, infra-red and ultra-violet light wavelengths.

Other aspects, features, and advantages will be apparent to one skilled in the art from the description herein taken in conjunction with the accompanying drawings.

### DESCRIPTION OF THE DRAWINGS

For the purposes of illustration, one or more embodiments are shown in the drawings, it being understood, however, that the embodiments disclosed and described herein are not limited to the precise arrangements and instrumentalities shown.

FIG. 1 is a schematic view of a glass substrate with a coating of material thereon;

FIG. 2 is a schematic, side view of the coated glass substrate of FIG. 1 taken through cross-sectional line 2-2;

FIG. 3 is a schematic, side view of an alternative embodiment of the coated glass substrate of FIG. 1 taken through cross-sectional line 2-2; and

FIG. 4 is a graph showing the results of an Impact test on a number of samples having the general configuration of FIG. 2 (where the coating is on an edge of the glass substrate); and

FIG. 5 is a graphical representation of the results of an abrasion test performed a number of samples having the general configuration of FIG. 2 (where the coating is on an edge of the glass substrate).

### DETAILED DESCRIPTION

Various embodiments disclosed herein are directed to improving one or more functional properties of a glass substrate by applying a coating onto the substrate. In order to provide a fuller understanding of how the discoveries herein were achieved, and therefore the broad scope of the contemplated embodiments, a discussion of certain experimentation and/or theory will be provided. It is noted, however, that the embodiments herein are not necessarily limited to any such experimentation and/or theory.

### General Structure

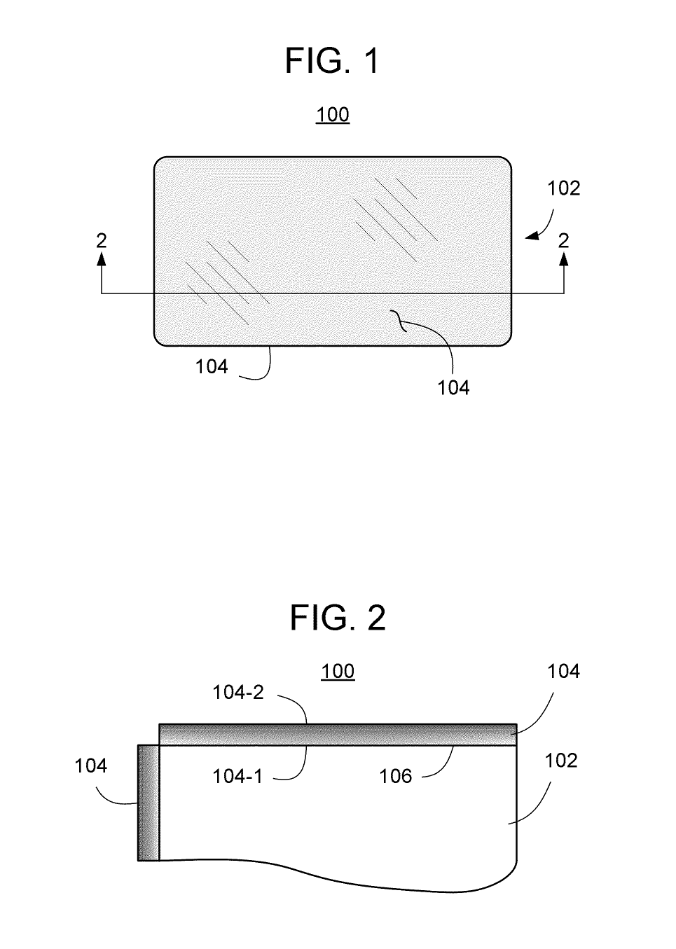

With reference to the drawing, FIG. 1 is a schematic view of a structure 100, and FIG. 2 is a schematic, side view of the structure 100 of FIG. 1 taken through cross-sectional line 2-2. The structure 100 may include a glass substrate 102 and a coating (or layer) 104 disposed on the substrate 102. The glass substrate 102 includes first and second opposing (major) surfaces, and a plurality of edge surfaces extending transversely between the first and second opposing surfaces. The coating 104 is disposed on, adhered to, and/or substantially covering at least one of the first, second, and edge surfaces of the substrate. It is noted that the phrase “substantially covering” herein means that the superior layer (i.e., the coating 104) overlies the inferior layer (i.e., the substrate 102) either directly or indirectly through one or more intermediate layers. In the illustrated example, an upper major surface 106 of the glass substrate 102 includes a coating 104 thereon and a left edge surface of the glass substrate 102 also includes a coating 104 thereon. In the illustrated example of FIGS. 1-2, there are no intermediate layers shown between, for example, the coating 104 and the substrate 102, although such intermediate layers are contemplated.

In one or more embodiments, the coating 104 is a protective layer exhibiting certain characteristics, such as one or more of: (i) high indentation fracture threshold and/or static indentation fracture resistance; (ii) high edge impact resistance; (iii) high scratch and/or abrasion resistance; (iv) low yellowness; and (v) high transparency.

With reference to FIG. 2, the coating 104 may be formed via a single layer of material. By way of example, a coating 104 of a single layer of material may be formed in a process in which one application of material is deposited, resulting in one integrated coating 104 of material (FIG. 2). Alternatively, the coating 104 may be formed in a process in which multiple applications of material are provided, which nevertheless result in one integrated coating 104 of material, as opposed to discrete layers of material.

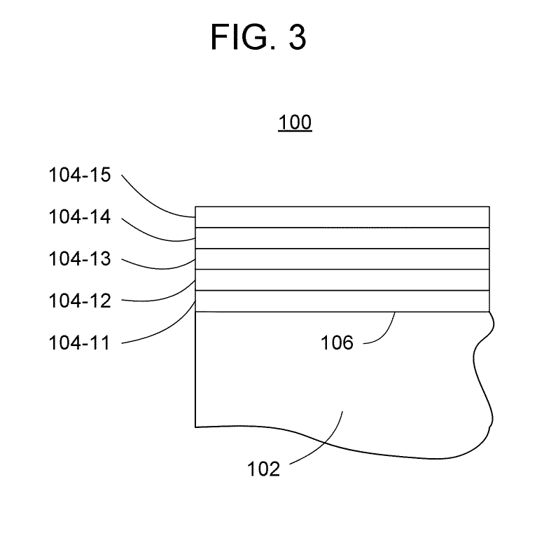

Alternatively, with reference to FIG. 3, the coating 104 may be formed via a plurality of discrete layers 104-11, 104-12, 104-13, 104-14, 104-15, etc. of material, one atop the other. The respective layers 104-i may have the same chemical compositions, characteristics, layer thicknesses, etc., or they may be of varying properties in to achieve desirable results.

### Thickness of the Coating

In most cases, the coating 104 is relatively thin as compared to the thickness of the glass substrate 102, e.g., the coating 104 will generally have a thickness within some range. For example, contemplated thickness ranges for the coating 104 include at least one of: (i) up to 100 microns; (ii) between about 10-100 microns; (iii) between about 20-80 microns; (iv) between about 20-50 microns; and (v) between about 20-30 microns. By way of example, such ranges may be suited to achieve the aforementioned performance characteristics, although in general, other thicknesses may be possible.

### Coating Composition and Properties

The specific materials and/or compositions of the coating 104 include, for example, urethane (meth)acrylate oligomer(s) or epoxy resins that are filled with nanometer-sized inorganic particles.

It has been discovered that the desired characteristic(s) discussed herein are achieved when close attention is paid to the percolation threshold of the nanometer-sized inorganic particles within the coating 104. The percolation threshold is a mathematical term related to the formation of long-range connectivity in random systems, such as lattice models of random systems or networks of the particles within the coating 104, and the nature of the connectivity therein. More specifically, the percolation threshold in the context of the disclosure herein relates to a critical value of the quantity of the nanometer-sized particles within the coating 104 (assuming a particular size distribution of the particles), and the occupation probability associated with the particles within a lattice of the coating 104. When so-called “infinite connectivity” (percolation) occurs, the aforementioned desirable performance characteristics of the structure 100 result.

It has been found that percolation is achieved in connection with the contemplated coating compositions herein when the pre-cured coating 104 (in liquid form) contains nanometer-sized particles (such as silica particles) of one of: (i) at least about 2-50 weight percent; (ii) at least about 10-30 weight percent; (iii) between about 10-20 weight percent; (iv) between about 10-15 weight percent; and (v) at least about 14 weight percent.

As mentioned above, the percolation threshold was considered in connection with nanometer-sized particles (such as silica particles) of a particular size distribution. Thus, additionally and/or alternatively, the size distribution of the nanometer-sized particles may include that at least 70-percent of the nano-sized particles (e.g., silica) have diameters of one of: (i) between about 5-nm; (ii) between about 7-35 nm; (iii) between about 10-30 nm; (iv) between about 15-25 nm; (v) between about 17-23 nm; and (vi) about 20 nm.

Additionally and/or alternatively, the composition of the coating 104 may include one or more specific substances, including one or more of: (i) one of an oligomer and resin; (ii) a monomer; and (iii) the nanometer-sized particles, such as silica.

For example, the oligomer may be a urethane acrylate, such as an aliphatic urethane acrylate. Additionally and/or alternatively, the oligomer may be present in the coating 104 in a specific quantity, such as one of: (i) between about 40-60 weight percent; and (ii) about 50 weight percent.

By way of further example, the monomer may be at least one of diethylacrylamide and cyclic trimethylolpropane formal acrylate. Additionally and/or alternatively, the monomer may be present in the coating 104 in a specific quantity, such as one of: (i) between about 40-60 weight percent; and (ii) about 40-50 weight percent.

In a specific configuration the coating 104 is of a composition in which the oligomer is an aliphatic urethane acrylate, and the monomer is at least one of diethylacrylamide and cyclic trimethylolpropane formal acrylate.

By way of further example, the resin may be an epoxy resin, such as cycloaliphatic epoxy resin. Additionally and/or alternatively, the resin may be present in the coating 104 in a specific quantity, such as one of: (i) between about 20-90 weight percent; (ii) between about 25-85 weight percent; (iii) between about 30-80 weight percent; (iv) between about 40-60 weight percent; and (v) about 50 weight percent.

In a specific configuration the coating 104 is of a composition in which the resin is a cycloaliphatic epoxy resin and the monomer is an oxetane monomer. In some embodiments, the oxetane monomer may be present in the coating 104 in an specific quantity, such as one of: (i) between about 2-60 weight percent; (ii) between about 3-50 weight percent; and (iii) between about 5-40 weight percent.

In a specific configuration, the coating 104 is formed from an ultra-violet curable composition.

As previously mentioned, the coating 104 preferably has a yellowness one of: (i) below about 10.00 ASTM D1925 index; (ii) below about 5.00 ASTM D1925 index; (iii) and below about 4.00 ASTM D1925 index.

Additionally and/or alternatively, the coating 104 is preferably substantially transparent (such as in the visible, UV and/or IR wavelengths).

In some embodiments, the coating compositions can be modified to produce special effects to enhance aesthetics or produce optical function. For example, this can include the addition of dyes or pigments for color, fluorescing or phosphorescing agents for aesthetic or optical effects, light blocking agents such as black pigments to block light from entering or leaving through the glass edge, surface-active agents to adjust coating roughness or gloss, specific light absorbing or transmitting agents to absorb or transmit specific wavelengths of light.

### Coating Process

The specific mechanisms and/or methods for achieving the coating process may be carried out using known techniques, such as vapor deposition techniques, which may include sputtering, plasma enhanced chemical vapor deposition (PECVD), or evaporation beam (E-beam) techniques. Those skilled in the art will appreciate, however, that the particular mechanism by which the coating 104 is applied is not strictly limited to the aforementioned techniques, but rather may be selected by the artisan in order to address the exigencies of a particular product application or manufacturing goal.

### Substrate Pre-Treatment Using Silane Coupling Agents

It has been found that certain pretreatment techniques may be employed to improve the adhesion of the coating 104 to the glass substrate 102. For example, the pretreatment techniques may include employing a silane coupling agent. The technique may include at least one of: (a) applying a silane coupling agent to the at least one of the first, second, and edge surfaces of the substrate 102 prior to disposing the liquid coating thereon; (b) including a silane coupling agent within the liquid coating composition; and (c) both (a) and (b).

Experimentation disclosed that the adhesion behavior of the coating 104 on one or more edges of the glass substrate 102 can be predicted by the adhesion behavior of the coating on a major surface of the glass substrate 102. Indeed, if the coating 104 does not adhere well to the major surface of the glass substrate, then the coating 104 will not adhere well to an edge of the glass substrate.

A number of specimens of the structure 100 were prepared and subject to dry and wet adhesion tests. The glass substrates 102 were coated with a coating 104 of 50-100 weight percent cycloaliphatic epoxy resin (with 40% by weight 20 nm spherical nano-silica), and less than 1 weight percent UV photo-initiator. Some of the substrates 102 were pretreated with a silane coupling agent, while others were not. Still other substrates 102 received a coating composition that includes a 6% silane additive. The pretreatment of some of the substrates 102 to the silane coupling agent included dip coating the substrates 102 in a 2 wt % silane (2-(3,4-epoxy cyclohexyl)-ethyl triethoxy silane) in water/ethanol (5/95) solution, followed by a 10 minute cure at 100° C. After coating, all samples of the structures 100 were subject to a UV cure (at four feet per minute) and then thermally cured, as shown in Table 1.

The dry adhesion test was conducted using the known ASTM Tape test method (D3359-09E2) and a glass cutting method, whereby the samples were then observed under a microscope for delamination. A summary of the results are provided in Table 1.

TABLE 1

| | | | % Nano |
|---|---|---|---|
| Material dry adhesion | Curing profile | Delamination | silica |
| coating as received | UV + 100° C., 0.5 hr | Severe delam | 40 |
| coating as received | UV + 100° C., 16 hr | No | 40 |
| coating + 6% additive | UV + 100° C., 16 hr | No | 40 |
| coating + silane glass | UV + 100° C., 16 hr | No | 40 |
| coating | | | |
| coating + silane glass | UV + 150° C., | No | 40 |
| coating | 10 mins | | |

The wet adhesion test was conducted by immersing the test specimens in 80° C. hot water for six hours and then observing under microscope for signs of delamination. A summary of the results are provided in Table 2 below.

TABLE 2

| | | | % Nano |
|---|---|---|---|
| Material | Curing profile | Delamination | silica |
| coating as received | UV + 100° C., 0.5 hr | Severe delam | 40 |
| coating as received | UV + 100° C., 16 hr | Severe delam | 40 |
| coating + 6% additive | UV + 100° C., 16 hr | Severe delam | 40 |
| coating + silane glass | UV + 100° C., 16 hr | No | 40 |
| coating | | | |
| coating + silane glass | UV + 150° C., | No | 40 |
| coating | 10 mins | | |

The above results of the dry and wet adhesion tests reveal that the only sample that passes both dry and wet adhesion test was a sample in which the glass substrate 102 was pre-treated with the silane coupling agent. The as received coating failed the wet adhesion test. Adding silane into the coating liquid (up to 6 wt %) did not significantly improve the wet adhesion behavior, presumably due to poor silane diffusion to the coating/glass interfaces.

By way of example, the silane coupling agent may be taken from one or more of: 3-amino-propyl triethoxy silane; 3-amino-propyl trimethoxy silane; amino-phenyl trimethoxy silane; 3-amino-propyl tris(methoxyethoxy ethoxy) silane; 3-(m-amino-phenoxy) propyl trimethoxy silane; 3-amino-propyl methyldiethoxy silane; n-(2-aminoethyl)-3-aminopropyltri-methoxysilane n-[3-(trimethoxysilyl)propyl]ethylenediamine damo silane; n-(2-aminoethyl)-3-aminopropyltri ethoxy silane; n-(6-aminohexyl)aminomethyl-trimethoxy silane; n-(2-aminoethyl)-11-aminoundecyl-trimethoxy silane; (aminoethylaminomethyl) phenethyl-trimethoxy silane; n-3-[(amino(polypropylenoxy)]aminopropyltrimethoxy silane; (3-trimethoxysilylpropyl) diethylene triamine silane; (3-trimethoxysilylpropyl) diethylene-triamine silane; n-phenylaminopropyltrimethoxy silane; n-phenylaminomethyltriethoxy silane; bis(trimethoxysilylpropyl) amine silane; bis[(3-trimethoxysilyl)propyl]-ethylenediamine silane; bis[3(triethoxysilyl)propyl]urea silane; ureidopropyltriethoxy silane; ureidopropyltrimethoxy silane; 2-(3,4-epoxycyclohexyl)ethyltriethoxy silane; 2-(3,4-epoxycyclohexyl)ethyl-trimethoxy silane; (3-glycidoxypropyl)trimethoxysilane 3-(2,3-epoxypropoxy) propyltrimethoxy silane; (3-glycidoxypropyl)triethoxy silane; 5,6-epoxyhexyltriethoxy silane; 3-mercaptopropyltrimethoxy silane; and 3-mercaptopropyltriethoxy-silane.

### Substrate Pre-Treatment Using Etching

It has been found that another pretreatment technique may be employed to improve the adhesion of the coating 104 to the glass substrate 102, specifically employing a process to etch at least one of the first, second, and edge surfaces of the substrate 102 prior to applying the liquid coating 104.

An acid etch process may be applied to the glass substrate 102 in order to improve the strength of the glass (especially at an edge thereof). Indeed, the etching process removes or reduces the sizes and levels of defects and/or weak layers of material on the glass.

It has been found that in some embodiments, the etch process in combination with a pre-treated glass substrate 102 with a silane coupling agent and an edge coating 104 improves the glass edge strength against a sharp contact test, such as an abraded 4 point bend test. In order to combine these two processes for the best manufacturing scenario, and highest cost saving, without losing silane coating functionality, the silane pre-treatment should be performed after the acid etch process, but before the acid etch protection films or coatings are removed. This enables the protection films or coatings to prevent the silane application from contaminating the glass surface, which has different functional coatings. The particular silane for the pre-treatment application must be carefully selected to survive the solvent treatment to remove the acid etch protection films or coatings.

To demonstrate the effects of the etch process, a number of experiments were carried out using an ES28 coating material (a nano-silica filled epoxy material available from Master Bond), and a UV22 coating (a 50-100 weight percent cycloaliphatic epoxy resin, with 40% by weight 20 nm spherical nano-silica, and less than 1 weight percent UV photo-initiator). The sample structures 100 were tested using an abraded 4 point bend method.

Some sample structures included glass substrate 102 that were pre-treated with a silane coupling agent and then coated with UV22 or ES28. In particular, a 2 wt % silane (2-(3,4-epoxy cyclohexyl)-ethyl triethoxy silane) in a water/ethanol (5/95) solution was prepared. Both acid etch and non-etched glass substrates 102 were dip coated with the silane solution, followed by a 10 minute cure at 100° C. The silane pre-treated glass substrates 102 were dip coated with the UV22 or the ES28 to establish a coating 104 on the edges thereof, followed by a UV cure (20j/cm2) and a thermal cure (at 150° C. for 2 hrs).

The samples were then subjected to the 4 point bend test at 5 psi abrasion. The results are shown in the table below (Table 3). The B10 strength of a sample with a UV22 coating on an etched, silane pre-treated substrate 102 goes from 77 Mpa (which were the control samples with no coating) to 648 Mpa. The B10 strength of a sample with an ES28 coating on an etched, silane pre-treated glass substrate goes from 77 Mpa to 676 Mpa. The B10 strength of a sample with an ES28 coating on a non-etched, silane pre-treated glass substrate goes from 77 Mpa to 184 Mpa. Finally, the B10 strength of a sample with an ES28 coating (with silane additive) on a non-etched glass substrate goes from 77 Mpa to 247 Mpa. These results indicate that the glass etch process before silane pretreatment provides an improvement for glass edge and surface protection properties. Indeed, the etch process removes or reduces the size of defects and weak layers, such as on the edge of the glass substrate 102.

TABLE 3

| | | B10 Strength (Mpa) | | Scale Parameter (Mpa) | |
|---|---|---|---|---|---|
| Material & Curing Condition | Etch | Uncensored | Censored | Uncensored | Censored |
| ES28 (UV22 + 2% silane additive) + | Yes | | 676 | | 806 |
| UV + 150° C., 2 hours | | | | | |
| UV22 (0% silane additive) + silane | Yes | 648 | 596 | 840 | 826 |
| glass coating + UV + 150° C., 2 hours | | | | | |
| ES28 (UV22 + 2% silane additive) + | No | 247 | | 275 | |
| UV + 150° C., 2 hours | | | | | |
| ES28 (UV22 + 2% silane additive) + | No | 184 | | 245 | |
| UV + 150° C., 2 hours + silane glass | | | | | |
| coating | | | | | |
| Control glass | Yes | 77 | 77 | 175 | 176 |

As mentioned above, in order to perform the etch process, then the silane pre-treatment, and then the etch protection film or solvent removal process, the particular silane must be selected such that it can survive the downstream process.

An example was conducted to show that a properly selected silane can survive the etch protection film and coating solvent strip removal process without losing adhesion promotion functionality. In this example, a (2-(3,4-epoxy cyclohexyl)-ethyl triethoxy silane) was used for pre-treatment of the glass substrate, and an ES28 material was used to coat the substrate. In particular, a 2 wt % silane (2-(3,4-epoxy cyclohexyl)-ethyl triethoxy silane) in water/ethanol (5/95) solution was prepared. The glass substrate was dip coated with such silane solution, followed by a cure for 10 minutes at 100° C. Next the silane pre-treated substrates were treated using the following solvents (which are used for acid etch protection film and coating removal): (a) ethanol immersion for 20 minutes at 65° C. (solvent and treatment condition to remove protection film Seil Hi-tec ANT-25-550g); (b) 3 solvents immersion+IPA diluted base rinse for 5 minutes at 25° C. (solvents and treatment condition to remove protection coating WJ-678B from Vitayon Chemical industry Co.); (c) NMP immersion for 15 minutes at 70° C. (solvents and treatment condition to remove protection coating from Corning); and (d) Semi-clean KG (2%) immersion for 5 min at 25° C. (solvents and treatment condition to remove protection coating from Corning). Control samples were also prepared with no solvent treatment. The silane pre-treated and solvent treated glass substrates were then coated with ES28 material (using a 2 mil coating bar), followed by a UV cure (20 j/cm2) and a thermal cure (150° C. for two hours).

The samples were subjected to a dry adhesion test, an 80° C. 6 hour water immersion adhesion test, and a fracture indentation test. The experiment output variables were: (i) dry and water adhesion tests for silane pre-treated, solvent treated and ES28 coated glass substrates; and (ii) maximum threshold fracture indentation load (Kg) for silane pre-treated, solvent treated and ES28 coated glass substrates.

The results are shown in the table below (Table 4), which show that all silane pre-treated, solvent treated, and ES28 coated samples show a very smooth surface and have good dry adhesion. All samples pass the water adhesion test with no coating delamination. All of the silane pre-treated, solvent treated, and ES28 coated samples show an indentation fracture threshold load between 35 to 45 kg, which are all equal or better than the control silane pre-treated, no solvent treated, samples (35 Kg), and all of which pass a goal of 25 Kg. The silane pre-treated and solvent treated samples perform as well as silane pre-treated and non-solvent treated control sample in adhesion and indentation tests.

TABLE 4

| | Etch protection: | | | | |
|---|---|---|---|---|---|
| | Seil Hi-tec | Etch protection: | Etch protection: | Etch protection: | Control |
| | ANT-25-550 g | WJ-678B | Corning | Corning | samples |
| silane and | Ethanol, | 3 solvents | NMP 70° C. | Semi-clean KG | No solvent |
| solvent | 65° C. | immersion + | immersion, | (2%), 25° C. | treatment |
| treatment | immersion, 20 | IPA dilute base | 15 minutes | immersion, 5 | |
| | minutes | rinse | | minutes | |
| | | 25° C., 5 | | | |
| | | minutes | | | |
| Dry and | Pass, No | Pass, No | Pass, No | Pass, No | Pass, No |
| water | delamination | delamination | delamination | delamination | delamination |
| adhesion | | | | | |
| test | | | | | |
| Indentation | Fracture | Fracture | Fracture | Fracture | Fracture |
| test | Threshold load | Threshold load | Threshold load | Threshold load | Threshold |
| | 45 kg | 35 kg | 35 kg | 45 kg | load 35 kg |

These results indicate that the silane pre-treatment survives the acid etch protection film and coatings solvent removal treatment processes without losing adhesion promoter functionality.

### Ultra-Violet Curing

The coating 104 may be in liquid form when initially disposed on the glass substrate 102 and thereafter cured to form the coating 104. For example, the liquid coating may be formed from an ultra-violet (UV) curable composition and the step of curing the liquid coating may include applying ultra-violet light to form the coating 104. Additionally, the structure 100 may be subject to convection thermal heat after the UV cure to build up polymer crosslinking density and to provide strong and tough mechanical characteristics.

### Infra-Red Cure

Alternatively, the step of curing the liquid coating may include applying infra-red (IR) light to the liquid coating (even though the liquid coating is a UV curable composition). In some embodiments, the IR cure may follow the UV cure, while in other embodiments, the IR cure may substitute for a UV cure. For example, as mentioned above, the structure 100 may be subject to convection thermal heat after the UV cure to build up polymer crosslinking density, however, instead of the convection thermal heating, an IR cure method may be applied as a post UV cure process.

An IR cure may provide several advantages, including that the glass substrate 102 orientation may be maintained, minimizing glass handling and providing a continuous process. Indeed, to provide a convection cure, the structures 100 have to be removed from the coating process and put in a furnace as part of a batch process. Further, the IR cure can reduce the curing time while maintaining the coating performance, thereby increasing production through put, permitting larger structure sizes, and providing labor and cost savings.

The mechanism of an IR cure is to heat up the target object, in this case the structure 100, specifically the coating 104, through radiation from an IR filament. The efficiency of the IR filament is related to matching the emitted IR wavelength and absorption spectrum of the material to be heated. In an IR cure set-up, after coating the substrate 102, the structure 100 may be moved on a belt from the coating station to an IR tunnel for curing.

It has be discovered that excellent glass surface protection are achievable through a continuous IR cure of the structure 100, for example, in terms of coating adhesion and indentation fracture testing, despite radically shorter cure times. For example, structures 100 cured using convection heating in a furnace at 150° C. for two 2 hours exhibited about the same adhesion and indentation fracture thresholds as compared with structures 100 receiving an IR cure for 10 minutes. This discovery indicates that IR emitted wavelengths matched the absorption spectrum of the UV curable coating 104 and accelerated the crosslinking reaction to higher crosslink degrees, resulting in high mechanical strength. By way of further example, the IR curing process may employ multiple passes, where each pass employs a temperature increase, such as starting from 100° C. and stepping up to 200° C. at the final pass. For example, six passes may be used in a 10 minute span. The multiple passes at elevating temperatures may contribute to faster crosslinking reactions (e.g., for epoxy based coating compositions). In comparison, the conventional convection thermal cure process normally has a temperature lag, and takes longer for an epoxy crosslink reaction to kick off and complete.

Experimentation disclosed that the adhesion behavior of the coating 104 on one or more edges of the glass substrate 102 can be predicted by the adhesion behavior of the coating on a major surface of the glass substrate 102. Indeed, if the coating 104 does not adhere well to the major surface of the glass substrate, then the coating 104 will not adhere well to an edge of the glass substrate.

Experimentation of the IR cure techniques has been carried out using a number of sample structures 100. The samples included structures 100 prepared with different coating materials, including: an ECE1 coating material, a UV22 coating material, an ES28 coating material (a nano-silicate filled epoxy material available from Master Bond), and an EPOF (a hybrid plastic, nano-silicate filled epoxy material). The ECE1 composition included 48 weight percent cycloaliphatic epoxy resin (with 40% by weight 20 nm spherical nano-silica), 48 weight percent oxetane monomer with 50% by weight 20 nm spherical nano-silica, 1 weight percent cationic photo-initiator, and 1 weight percent silane adhesion promoter. The UV22 composition included: 50-100 weight percent cycloaliphatic epoxy resin (with 40% by weight 20 nm spherical nano-silica), and less than 1 weight percent UV photo-initiator.

Some of the coated glass substrates 102 were UV cured (20 j/cm2) and thermally cured in an oven (150° C. for 10 minutes followed by 2 hours). Others of the coated glass substrates 102 were also UV cured (20 j/cm2), but were then IR cured for 6 passes (in 10 minutes), 9 passes (in 15 minutes), and 12 passes (in 20 minutes) in an IR tunnel at 530 and belt speed at 0.5″/s. Still other samples included glass substrates that were first pre-treated with a silane coupling agent. Such glass substrates were dip coated in 2 wt % silane (2-(3,4-epoxy cyclohexyl)-ethyl triethoxy silane) in water/ethanol (5/95) solution, followed by a cure of 10 minutes at 100° C. Some of these silane pre-treated structures were subject to the UV and convection cure (discussed above), while others were subject to the UV and IR cure process (discussed above).

The sample structures 100 were then subject to dry and wet adhesion tests. The dry adhesion tests were conducted by ASTM Tape test method (D3359-09E2) and glass cutting method and observed under a microscope for evidence of delamination. The wet adhesion test was conducted by immersing the structures 100 in 80° C. hot water for 6 hours and then checking them under a microscope for evidence of delamination.

The following table (Table 5) shows the results of dry and wet adhesion tests for the ECE1 coating.

TABLE 5

| | No silane | UV cure | 80 C. |
|---|---|---|---|
| ECE1 | primer coating | energy (20 J/cm2) | 6 hours water |
| IR cure pass | IR expose time | Dry adhesion test | adhesion test |
| 6 passes | 10 minutes | pass | pass |
| 9 passes | 15 minutes | pass | pass |
| 12 passes | 20 minutes | pass | pass |
| | No silane | | |
| ECE1 | primer coating | UV cure | 80 C. |
| Thermal | Thermal | energy (20 J/cm2) | 6 hours water |
| expose Temp. | expose time | Dry adhesion test | adhesion test |
| 150 C. | 10 minutes | Fail | Fail |
| 150 C. | 120 minutes | Pass | Pass |

It can be seen that the samples that pass both dry and wet adhesion test are the samples cured by IR (for 10 minutes) and samples cured by thermal oven (for 2 hour). The samples thermally cured in the oven for 10 minutes failed both dry and wet adhesion tests. These results show that the IR cure method has very good curing efficiency and exhibits a very short cycle time (e.g., 10 minutes for the IR cure versus 120 minutes for the thermal cure), provide good adhesion between epoxy polymer and the glass, and passes the dry and wet adhesion tests.

Similar results were obtained for the other coatings UV22, ES28 and EPOF when compared to thermal cured method, as is shown in the following table (Table 6).

TABLE 6

| UV22 | Silane | UV cure energy | |
|---|---|---|---|
| IR | primer coating | (20 J/cm2) | 80 C. 6 hours water |
| cure pass | IR expose time | Dry adhesion test | adhesion test |
| 6 passes | 10 minutes | pass | pass |
| 9 passes | 15 minutes | pass | pass |
| 12 passes | 20 minutes | pass | pass |
| UV22 | | | |
| (no silane) | | | |
| Thermal | No coating | UV cure energy | |
| expose | Thermal expose | (20 J/cm2) | 80 C. 6 hours water |
| Temp. | time | Dry adhesion test | adhesion test |
| 150 C. | 10 minutes and | Fail | Fail |
| | 2 hours | | |
| ES28 | | | |
| (3% with | No Silane | | |
| silane) | primer coating | UV (20 J/cm2) | 80 C. 6 hours water |
| IR passes | IR expose time | Dry adhesion test | adhesion test |
| 6 passes | 10 minutes | pass | pass |
| 9 passes | 15 minutes | pass | pass |
| 12 passes | 20 minutes | pass | pass |
| ES28 | No Silane | | |
| Thermal | primer coating | | |
| expose | Thermal expose | UV (20 J/cm2) | 80 C. 6 hours water |
| Temp. | time | Dry adhesion test | adhesion test |
| 150 C. | 10 minutes | Fail | Fail |
| 150 C. | 120 minutes | Pass | Pass |
| | No Silane primer | | |
| EPOF | coating | UV (20 J/cm2) | 80 C. 6 hours water |
| IR passes | IR expose time | Dry adhesion test | adhesion test |
| 6 passes | 10 minutes | pass | pass |
| EPOF | 150 C. | Fail | Fail |
| | 10 minutes | | |
| | 150 C. | pass | pass |
| | 120 minutes | | |

The sample structures 100 (with non-ion exchange glass substrates) were used for sharp contact indentation tests. Both the silane pre-treated glass substrate samples and those without such pre-treatment were coated with ECE1 and UV22 coatings 104, followed by UV cure (20 J/cm2), thermal cure at 150 C for 2 hours or IR cure for 10 minutes (6 passes) before being subjected to the sharp contact indentation test. The final coating thickness was about 50 microns. The results of the indentation test are shown in the table below (Table 7). For UV22, EPOF and ECE1 coatings, the indentation threshold fracture load (Kg) of both the thermal cure at 150° C. for 2 hours and the IR cure for 10 minutes is in the 35 to kg range, which is comparable and acceptable as both approaches surpass a 25 kg goal.

TABLE 7

| | Indentation | FIT |
|---|---|---|
| | Threshold | Program |
| Coating material, curing profile | Fracture Load | Goal |
| and coting thickness | (Kg) | (25 kg) |
| UV22 + silane primer coating, 50 micron | 35 | Pass goal |
| UV + 150 C., 2 hours, no delay cure | | |
| UV22 + silane primer coating, 50 micron | 45 | Pass goal |
| UV + 150 C., 2 hours, 24 hrs. delay cure | | |
| UV22 + silane primer coating, 50 micron | 45 | Pass goal |
| UV + IR 10 minutes, no delay cure | | |
| UV22 + silane primer coating, 50 micron | 45 | Pass goal |
| UV + IR 10 minutes, 24 hrs. delay cure | | |
| ECE1 + silane primer coating, 50 micron | 35 | Pass goal |
| UV + 150 C., 2 hours, no delay cure | | |
| ECE1 + silane primer coating, 50 micron | 45 | Pass goal |
| UV + 150 C., 2 hours, 24 hrs delay cure | | |
| ECE1 + silane primer coating, 50 micron | 55 | Pass goal |
| UV + IR 10 minutes, no delay cure | | |
| ECE1 + silane primer coating, 50 micron | 35 | Pass goal |
| UV + IR 10 minutes, 24 hrs. delay cure | | |
| ECE1, 50 micron | 45 | Pass goal |
| UV + 150 C., 2 hours, no delay cure | | |
| ECE1, 50 micron | 35 | Pass goal |
| UV + 150 C., 2 hours, 24 hrs. delay cure | | |
| ECE1, 50 micron, | 35 | Pass goal |
| UV + IR 10 minutes, no delay cure | | |
| UV + IR 10 minutes, 24 hrs. delay cure | 55 | Pass goal |
| EPOF, 50 micron, | 35 | Pass goal |
| UV + 150 C. 2 hours, 24 hrs. delay cure | | |
| EPOF, 50 micron, | 35 | Pass goal |
| UV + IR 10 minutes, 24 hrs. delay cure | | |

The above indentation results indicate that the IR cure method provides excellent mechanical characteristics, meeting glass protection goals with much lower cycle times (10 minutes) as compared to conventional cure methods (150° C. for 2 hours).

Edge coatings of UV22 and ECE1 were also evaluated by TMA. The testing compared coatings post-cured by heating to 150° C. for 2 hours and heating via IR for 10 minutes. Coatings were applied on flat glass substrates, post-cured, and then subjected to TMA testing. Coated glass samples were placed flat on the TMA stage, and the probe set directly on the coating. The temperature program cooled each sample to −20° C., held each sample at −20° C. for 10 minutes, and then heated each sample to 180° C. at 5° C./min. The load on each sample was set at 0.4 N (40 gm). Some samples, labeled (a), received an IR cure or thermal cure, following an initial UV cure. Other samples, labeled (b), received a thermal cure 24 hours after an initial UV cure.

The resulting thermograms showed a change from positive expansion to negative as the coating softened. The temperature of this change was calculated and reported as a Tg value for the coating. The total negative deflection at the softening was also computed and recorded. The results are summarized in the table below (Table 8). For the ECE1 coating, Tg for both the IR cure (for 10 minutes) and the thermal cure (at 150° C. for 2 hours) was comparable; however, the results indicate improved performance for the IR cure. This conclusion is drawn from the significantly smaller deflection as Tg is reached for the IR cure coating as opposed to the thermal cure.

For the UV22 coating, the results also indicate comparable performance of the IR cure and the longer thermal cure. It can be seen that for the UV22 sample (a), the deflection from the first (lower temperature) Tg is roughly the same. The second Tg is slightly higher for the thermal cure coating; however, at the end of the test, the overall dimension change for both tests was very close (within 0.4 microns). This Tg study indicates that the ECE1 coating with the IR cure has better performance characteristics than the thermal cure coating. It also shows that the performance for the UV22 coating appeared comparable for both post-cures.

TABLE 8

| | | | Dimension | | |
|---|---|---|---|---|---|
| Line | Run | | Change | | |
| # | # | Coating/cure conditions | (microns) | Tg (1) | Tg (2) |
| 1 | 148 | ECE1 - IR 10 min (b) | 0.30 | 60 | |
| 2 | 146 | ECE1 - IR 10 min (a) | 0.45 | 55 | |
| 3 | 144 | ECE1 - 150 C. - 2 hours (a) | 2.78 | 44 | |
| 4 | 149 | ECE1 - 150 C. - 2 hours (b) | 3.77 | 60 | |
| 5 | 143 | UV22 - IR-10 (a) | 0.34 | 49 | 153 |
| 6 | 145 | UV22 - 150 C. 2 hours (a) | 0.50 | 46 | 165 |

To summarize, in additional to the convectional thermal (oven) cure, the IR cure (using a tunnel method) can be used for the post UV cure processes to achieve shorter and less costly cycle times, while still increasing the polymer crosslinking density in the coating 104.

### Substrate Material and Characteristics

In the illustrated examples, the substrate 102 is substantially planar, although other embodiments may employ a curved or otherwise shaped or sculpted substrate 102. Additionally or alternatively, the thickness of the substrate 102 may vary, for aesthetic and/or functional reasons, such as employing a higher thickness at edges of the substrate 102 as compared with more central regions.

The substrate 102 may be formed of any suitable glass material, such as soda lime glass, alkali-free glass, alkali-containing glass, etc. By way of example, the glass may be formed from an ion-exchange glass, usually an alkali aluminosilicate glass or alkali aluminoborosilicate glass.

In preferred embodiments, the glass substrate 102 is formed from alkali-free glass, as certain of the desirable performance characteristics were markedly better when alkali-free glass was employed, such as the aforementioned indentation fracture resistance, and/or static indentation fracture resistance. In particular, the final indentation fracture threshold of a coated alkali-free glass substrate was about ten times (an order of magnitude) better as compared to an initial indentation fracture threshold of the non-coated glass.

By way of example, the glass substrate 102 may be formed from an alkaline earth boroaluminosilicate composition. Among the suitable compositions of such glass is as follows: 65%≦SiO2≦75%; 5%≦B2O3≦15%; 7%≦Al2O3≦13%; 5%≦CaO≦15%; O%≦BaO≦5%; 0%≦MgO≦3%; and 0%≦SrO≦5%.

### EXAMPLES

A number of samples adhering to the general characteristics of structure 100 as discussed herein were evaluated using various testing techniques.

In one series of experiments, glass substrates 102 were formed from both ion exchanged (IX) and non-ion exchanged (Non-IX) alkali aluminosilicate or alkali aluminoborosilicate glass (e.g., Corning Gorilla glass) with a chamfer edge finish. The substrates 102 were pre-cleaned by heating to 550° C. for 3 hours, and then the edges of the substrates 102 were primed with 3-acryloxy propyl trichloro silane (APTCS) by wiping each edge with an APTCS soaked swab, rinsing with ethanol, and then allowing the ethanol to evaporate. The coatings 104 were applied to the edge(s) of the glass substrate 102 using a computer-driven syringe with a needle that dispenses a bead of material as the syringe traces the perimeter of the glass substrate 102. The bead of material is then spread to cover the entire edge using a second pass around the perimeter wherein the edge, or the side of the needle spreads the bead. The material of the coating 104 was then UV cured in a nitrogen environment. The UV light was provided by a Fusion Systems 600 W/in D lamp at 100% power and 5 ft/min conveyor belt speed.

The various compositions of the coatings 104 are summarized in the table below (Table 9).

TABLE 9
UV Curable Coating Compositions.

| | Composition Numbers | | | | | | | | | | | | |
|---|---|---|---|---|---|---|---|---|---|---|---|---|---|
| | 61-1 | 29-1 | 30-1 | 30-2 | 33-1 | 33-2 | 33-3 | 33-4 | 33-5 | 36-3 | 36-4 | 39-1 | 39-2 |
| Ingredient | Percent by Weight | | | | | | | | | | | | |
| Methyl benzoyl formate | 0.2 | 0.2 | 0.2 | 0.2 | 0.2 | 0.2 | 0.2 | 0.2 | 0.2 | 0.2 | 0.2 | 0.2 | 0.2 |
| 3-Acryloxypropyltrimethoxysilane | 3.0 | 3.0 | 3.0 | 3.0 | 3.0 | 3.0 | 3.0 | 3.0 | 3.0 | 3.0 | 3.0 | 3.0 | 3.0 |
| Sartomer CD9053 | 3.0 | 3.0 | 3.0 | 3.0 | 3.0 | 3.0 | 3.0 | 3.0 | 3.0 | 3.0 | 3.0 | 3.0 | 3.0 |
| Echo Resins ALU351 | 50.0 | | 50.0 | | | | | | | | | | |
| N,N-Diethylacrylamide | 43.8 | 43.8 | | | 43.8 | | 43.8 | | | 43.8 | | | |
| Echo Resins ALU350 | | 50.0 | | | | | | 50.0 | | | | | |
| N,N-Dimethylacrylamide | | 43.8 | 43.8 | | | | | 43.8 | 43.8 | | | | |
| Bomar BR543 | | | 50.0 | | | | | | | | | | |
| Sartomer CN985B88 | | | | 50.0 | 50.0 | | | | | | | 50.0 | |
| Sartomer SR531 | | | | | 43.8 | | | | | | 43.8 | | |
| Sartomer CN996 | | | | | | 50.0 | | | 50.0 | | | | |
| Ebecryl 8311 | | | | | | | | | | 50.0 | 50.0 | | 50.0 |
| Nanocryl C-130 | | | | | | | | | | | | 43.8 | 43.8 |

The impact resistance of the coated edges of the samples were evaluated using a sliding drop test, which employs a cart containing the sample on a ramp at a given distance from the target or impact surface (which is made of a suitable material, such as granite with high quartz content). Friction on the ramp is minimized by oiling the surface and using polyethylene sliders at the bottom of the cart. The cart and ramp are oriented with respect to the target such that the corner of an edge (the transition from the major surface to the edge surface of the sample) impacts the granite at 45°. Thus, the impact is equivalent to the kinetic energy of the part as if it free fell vertically from that height. The testing method included increasing the drop height until cracks, checks, or chips are generated on the edge surface. A summary of the test results is provided in the table below (Table 10).

TABLE 10

| | Coating | | |
|---|---|---|---|
| Glass Part (FZ | Thickness | Crack Initiation | |
| 50 × 100 × 1.5 mm) | (μm) | Height (in) | Appearance After Impact |
| Non-IX uncoated | — | 8 | — |
| IX uncoated | — | 24 | — |
| Non-IX/polymer 61-1 | 37-53 | >65 | Slight de-lamination |
| IX/polymer 61-1 | 37-53 | >65 | Slight de-lamination |
| Non-IX/polymer 61-1 | 107 ac, 50-118 | 65 | De-lamination |
| Non-IX/polymer 29-1 | 30 ac, 35-81 | 24 | De-laminates, peels off |
| Non-IX/polymer 30-1 | 131 ac, 61-109 | 40 | De-laminates, peels off |
| Non-IX/polymer 30-2 | 117 ac, 45-70 | 38 | De-laminates, peels off |
| Non-IX/polymer 33-2 | 24 ac, 26-48 | >65 | Looked great up to 40″ |
| | | | then de-laminates slightly |
| Non-IX/polymer 33-3 | 70 ac, 35-150 | >65 | De-laminates, peels off badly |
| Non-IX/polymer 33-4 | 161 ac, 30-94 | 42 | De-laminates, peels off |
| Non-IX/polymer 33-5 | 50 ac, 40-157 | >65 | De-laminates, peels off |
| Non-IX/polymer 33-1 | | >65 | De-laminates, peels off |
| Non-IX/polymer 36-3 | | >65 | Looks almost intact |
| Non-IX/polymer 36-4 | 47-60 ac, 22-69 | >65 | Looks almost intact |
| Non-IX/polymer 39-1 | | 50 | Coating breaks off |
| Non-IX/polymer 39-2 | | <8 | Coating breaks off and glass |
| | | | cracks |

Uncoated Non-IX samples develop cracks when dropped from a height of about 8 inches, while uncoated IX samples develop cracks when dropped for a height of about three times higher, i.e., about 24 inches. The coated samples improved the impact performance significantly in that even when applied to Non-IX samples, several of the samples did not break even at the maximum height of 65 inches.

Indentation fracture experiments were also carried out to determine the threshold load for crack initiation. The edges of the samples were indented using a Vickers hardness test with a maximum load of 2 Kg. It was not possible to test uncoated edges due to the high roughness of the surface. However, uncoated non-IX glass of this type used typically cracks at 200-300 g loads. Some delamination of the coatings was evident by optical microscopy when focusing beneath the surface in the contact area.

Two of the coating compositions (numbered 36-3 and 36-4) exhibited notable results. As for the drop test, not only did these coatings prevent glass breakage at the maximum drop height, but they also exhibited almost no visible coating damage at the impact point. As for the indentations fracture tests, the 36-4 polymer coated samples did not exhibit cracking at the maximum load of the instrument (2 Kg), presumably due to the indenter not reaching the surface of the glass substrate 102. These urethane acrylate based compositions contained the nanometer-sized silica particles, and the details on the compositions are listed in the table below (Table 11).

TABLE 11

| | | | |
|---|---|---|---|
| Percent | Ingredient | Name | Ingredient Chemical Name |

36-3

| | | | |
|---|---|---|---|
| 50.0 | Oligomer | Ebecryl | 40% by weight 20 nm Nanosilica dispersed in aliphatic |
| | | 8311 | urethane acrylate |
| 43.8 | Monomer | DEAA | Diethylacrylamide |
| 0.2 | Photoinitiator | MBF | Methyl benzoylformate |
| 3.0 | Silane adhesion | APTMS | 3-Acryloxypropyltrimethoxysilane |
| | promoter | | |
| 3.0 | Adhesion promoter | CD9053 | Acrylate phosphate esters in TMPEOTA |

36-4

| | | | |
|---|---|---|---|
| 50.0 | Oligomer | Ebecryl | 40% by weight 20 nm Nanosilica dispersed in aliphatic |
| | | 8311 | urethane acrylate |
| 43.8 | Monomer | SR531 | Cyclic trimethylolpropane formal acrylate |
| 0.2 | Photoinitiator | MBF | Methyl benzoylformate |
| 3.0 | Silane adhesion | APTMS | 3-Acryloxypropyltrimethoxysilane |
| | promoter | | |
| 3.0 | Adhesion promoter | CD9053 | Acrylate phosphate esters in TMPEOTA |

Next, the samples with the 36-3 and 36-4 coatings were subjected to Impact testing, which measures the ability of an edge coating to protect the glass from damage by impact. The coating 104 was applied on a long edge of IX glass substrates 102 of dimensions 44×60×0.7 mm thick. The samples were coated with 1, 2, and 3 coats (which were about 30, 60, and 90 μm respectively, at a center thickness). For this test, one set of samples was measured for horizontal 4-point bend strength, and another set of the same edge coated samples was subject to the Impact test and measured for 4-point bend strength. The difference in the before-impact and after-impact characteristics in terms of the 4-point bend strengths is a measure of the coating ability to resist damage to the glass.

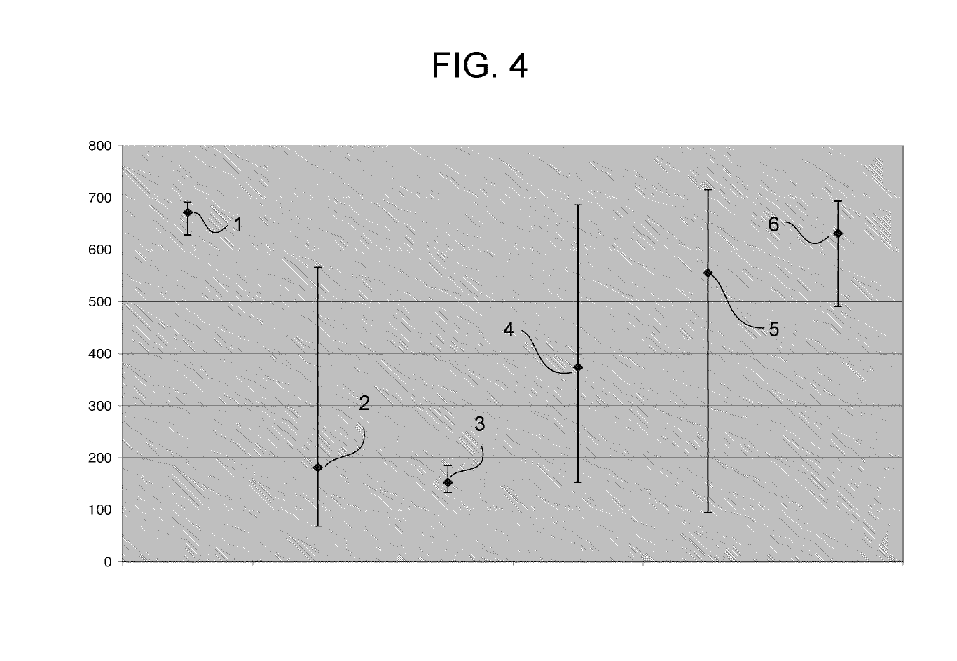

The results of the Impact test for samples with the 36-3 coating are shown in the graph of FIG. 4, whereby the Y-axis is strength in MPa and the minimum and maximum bars showing in the X direction for respective groups of samples (1, 2, 3, 4, 5, and 6). Group 1 is a no-impact control, group 2 is an impact test, group 3 have no coatings, group 4 have a one-layer coating, group 5 have a two-layer coating, and group 6 have a three-layer coating. Notably, the initial strength of group 1 (the bare glass without impact) is about 650 MPa, while groups 2 and 3 (the impact and no coating impact samples, respectively) have strengths in the 100-200 MPa range. Additionally, a sequential increase in strength with higher numbers of layers of coating was observed, where group 6 has almost the same strength as the non-impacted sample.

The static indentation fracture resistance was measured on samples with the 36-3 and 36-4 coating compositions applied to the major surfaces of the glass substrates 102. The glass substrates 102 were of alkali-free compositions, such as alkaline earth boroaluminosilicate compositions of Eagle XG, available from Corning Incorporated. The glass substrates 102 were cleaned for 10 minutes in a UVO cleaner, the surfaces to be coated were primed with APTCS, and then about 25 μm of material was applied to obtain the coating 104 (using a 1 mil Bird applicator). The samples were UV cured and then aged at least seven days in ambient conditions before testing.

The results of the static indentation fracture resistance of the samples are summarized in the two tables below (Tables 12 and 13). Note that the results for the 36-3 coating are about equal to the bare glass but the results for the 36-4 coating are about six times higher.

TABLE 12
36-3 Coating
Load (grams force)

| | 2000 | 1500 | 1000 |
|---|---|---|---|
| 1 | n | n | n |
| 2 | y | y | y |
| 3 | y | y | n y |
| 4 | y | y | n |
| 5 | n | y | y |
| 6 | | | |
| 8 | | | |
| 9 | | | |
| 10 | | | |

TABLE 13
36-4 Coating
Load (grams force)

| | 1000 | 2000 | 3000 | 4000 | 5000 | 6000 |
|---|---|---|---|---|---|---|
| 1 | n | n | n | n | n | n |
| 2 | n | n | n | n | n | y |
| 3 | n | n | n | n | n | y |
| 4 | n | n | n | | | n |
| 5 | n | n | | | | y |
| 6 | | | | | | |
| 7 | | | | | | |
| 8 | | | | | | |
| 9 | | | | | | |
| 10 | | | | | | |

Further testing was conducted on samples having the 36-4 coating and samples having a 71-3 coating. The composition of the 71-3 coating is summarized in the table below (Table 14).

TABLE 14
71-3 Coating

| Weight | | | |
|---|---|---|---|
| Percent | Ingredient | Name | Ingredient Chemical Name |
| 49.0 | epoxy | Nanopox | cycloaliphatic epoxy resin with |
| | | C 620 | 40% by weight 20 nm nanosilica |
| 49.0 | monomer | Nanopox | oxetane monomer with 50% by |
| | | C 680 | weight 20 nm nanosilica |
| 1.0 | pigment | Penn Color | 25% red pigment dispersion in |
| | | 18R 373 | cycloaliphatic epoxy resin |
| 1.0 | photoinitiator | Cyracure | cationic photoinitiator |
| | | UVI 6976 | |

The samples having the 36-4 and 73-1 coatings were evaluated in their ability to resist breaking in a tumble tester. In this test, both edge coated and non-edge coated samples are placed inside a chamber and the chamber rotates at about 3 rpm, which permits the samples to free fall from about 1 meter onto a flat stainless steel base surface. The number of drops are counted until the glass sample breaks.

The glass substrates 102 were IX Gorilla™ glass of 0.7 mm thickness, and prepared by cleaning for 10 minutes in UV ozone, and for the 36-4 composition primed with APTCS. The substrates 102 receiving the 71-3 coating were not primed. The respective coatings were applied by dipping the edges into a 3 mil deep drawdown of the liquid coating. The samples were UV cured and then baked overnight at 100° C.

The results of the tumble test on the samples are summarized in the table below (Table 15). Notably, the 71-3 coating provided outstanding results. Indeed, while the samples having the 36-4 composition had a maximum number of drops of 158 (for only one of the five samples), the samples having the 71-3 coating exhibited a maximum number of drops of over 300 (for three out of the five samples).

TABLE 15

| Edge | | | |
|---|---|---|---|
| Coating | | | 1 Meter |
| Formulation | | Sample | Drops |
| Number | Coating Type | Number | Passed |
| No coating | — | 1 | 4 |
| | | 2 | 8 |
| | | 3 | 8 |
| | | 4 | 4 |
| | | 5 | 2 |
| 14890-36-4 | Urethane acrylate | 1 | 32 |
| | | 2 | 105 |
| | | 3 | 64 |
| | | 4 | 35 |
| | | 5 | 158 |
| 15438-71-3 | Epoxy | 1 | 26 |
| | | 2 | 300+ |
| | | 3 | 300+ |
| | | 4 | 300+ |
| | | 5 | 51 |

Further testing was performed on samples having the 71-3 coating composition. In particular a number of samples were tested for static indentation fracture resistance. The samples includes glass substrates 102 of IX Gorilla™ glass and Eagle XG glass. The respective glass substrates 102 were coated with 25 μm of the respective materials. The results were as follows: (i) IX glass indentation fracture without coating was about 6-7 kilograms force (which is typical of IX glass); (ii) IX glass indentation fracture with coating was greater than 30 kgf (which was the limit of the test equipment); (iii) Eagle XG glass indentation fracture without coating is about 2 kgf (which is typical of Eagle XG glass); and (iv) Eagle XG glass indentation fracture with coating is about 17-20 kgf. These results show the outstanding ability of the 71-3 coating composition to protect both Eagle XG as well as IX glass from fracture by indentation with a diamond tip indenter.

Impact tests were also performed on samples having the 71-3 coating composition. The glass substrates 102 were made of IX Gorilla™ material, whereby a larger IX sheet was subsequently cut into the smaller substrates 102. This leaves glass substrates 102 have IX major surfaces, but bare Non-IX edges. The glass substrates 102 were edge coated with the 71-3 composition. The results were as follows: (i) for uncoated samples, 29 out of 30 samples failed; and (ii) for coated samples, only 4 out of 30 samples failed. For this test, a failure was recorded when: cracked all the way through the sample, cracks propagating from the impact site, or large chipping at the impact site. A sample passed the test when the sample was intact, except for a large induced flaw at the impact site.

Further testing (tumble testing) was conducted on samples employing further coating compositions, namely a 100-1 epoxy coating composition and a 30-3 urethane coating composition. The samples were prepared using substrates 102 formed from IX Gorilla™ material, whereby a larger IX sheet was subsequently cut into the smaller substrates 102. This leaves glass substrates 102 have IX major surfaces, but bare Non-IX edges. Some of the glass substrates 102 were edge coated with the 100-1 epoxy coating composition and some of the glass substrates 102 were edge coated with the 30-3 coating compositions.

The compositions of the 100-1 epoxy coating and the 30-3 urethane coating, respectively, are summarized in the two tables below (Tables 16 and 17).

TABLE 16
100-1 Coating

| Percent | | |
|---|---|---|
| By | Ingredient | |
| Weight | Trade name | Ingredient Chemical Type |
| 48.00 | Nanopox C-620 | Cycloaliphatic epoxy resin with 40% |
| | | by weight 20 nm spherical nanosilica |
| 48.00 | Nanopox C-680 | Oxetane monomer with 50% by |
| | | weight 20 nm spherical nanosilica |
| 1.00 | Cyracure UVI-6976 | Cationic Photoinitiator |
| 3.00 | Silquest A-186 | Silane adhesion promoter |

TABLE 17
30-3 Coating

| Percent | | |
|---|---|---|
| By | Ingredient | |
| Weight | Trade name | Ingredient Chemical Type |
| 44.00 | CN9009 | Aliphatic Urethane Acrylate Oligomer |
| 50.00 | 16046-27-1 | Acrylate monomer with 30% by weight |
| | | 20 nm spherical nanosilica |
| 3.00 | Irgacure 184 | Photoinitiator |
| 3.00 | APTMS | Silane adhesion promoter |

Again, the tumble testing protocol called for both edge coated and non-edge coated samples to be placed inside a chamber and the chamber rotated at about 3 rpm, which permits the samples to free fall from about 1 meter onto a flat stainless steel base surface. The number of drops are counted until the glass sample breaks. The results of the tumble testing are summarized in the table below (Table 18). Notably the samples having the 100-1 epoxy coating demonstrated a 4× improvement as compared with uncoated samples. Also, samples having the 30-3 urethane coating demonstrated a 10× improvement as compared with the uncoated samples.

TABLE 18

| Edge Coating | | | 1 Meter |
|---|---|---|---|
| Formulation | | Sample | Drops |
| Number | Coating Type | Number | Passed |
| No coating | — | 1 | 7 |
| | | 2 | 6 |
| | | 3 | 2 |
| | | 4 | 4 |
| | | 5 | 12 |
| | | Ave | 6.2 |
| 15438-100-1 | Epoxy | 1 | 6 |
| | | 2 | 30 |
| | | 3 | 17 |
| | | 4 | 39 |
| | | 5 | 20 |
| | | Ave | 22.4 |
| 16046-30-3 | Urethane | 1 | 29 |
| | | 2 | 34 |
| | | 3 | 88 |
| | | 4 | 85 |
| | | 5 | 73 |
| | | Ave | 61.4 |

Further testing (abrasion testing) was conducted on samples employing the 100-1 coating composition and the 30-3 coating composition. The samples were prepared using substrates 102 formed from IX Gorilla™ material, whereby a larger IX sheet was subsequently cut into the smaller substrates 102 (leaving bare Non-IX edges). Some of the glass substrates 102 were edge coated with the 100-1 epoxy coating composition and some of the glass substrates 102 were edge coated with the 30-3 coating compositions.

The abrasion test measures the ability of a coating to protect the edge of glass from abrasion by grit blasting. One edge of each sample was abraded by grit blasting with 1.3 g or 5 cc of 90 grit SiC particles for 5 seconds at 5 psi pressure. The samples are held vertically and the grit is fired straight down onto the coated (or uncoated) edge. Horizontal 4-point bend testing is then performed on the abraded, coated and uncoated samples and compared to un-abraded, coated and uncoated samples.

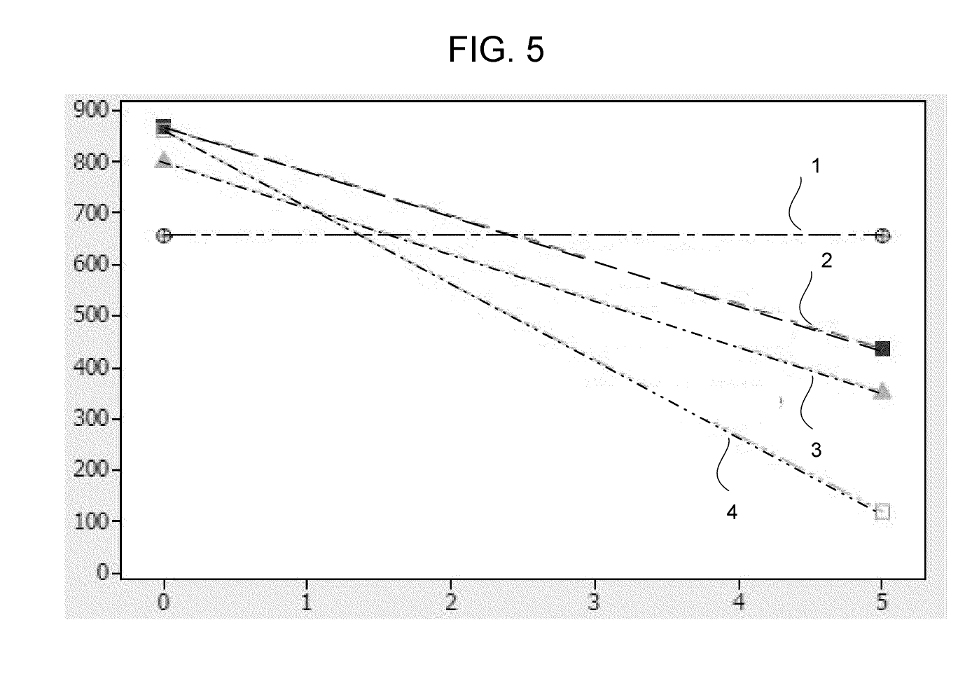

The results of the abrasion test appear in FIG. 5, which is a graph in which the Y-axis is the average 4-point bend strength in MPa, and the X-axis is abrasion pressure in psi. Plot 1 shows the data for a control sample that is discrete. Plot 2 shows the data for the sample having the 100-1 coating composition. Plot 3 shows the data for a sample having the 30-3 coating composition. Plot 4 shows the data for a sample that has unprotected edges. Notably, there is more than a 50% improvement in retained strength for the coated versus the uncoated samples after abrasion.

Further testing (pendulum edge impact testing) was conducted on samples employing the 100-1 coating composition and the 30-3 coating composition. The samples were formed using glass substrates 102 of 1.1 mm thick IX Gorilla™ material, whereby a larger IX sheet was subsequently cut into the smaller substrates 102 (leaving bare Non-IX edges). The test employed a tungsten carbide impactor, whereby the samples were struck at three different angles (40, 60, and 90 degrees) and two samples at each angle. After impact, pictures were taken of the impact sites and the samples were put into clear plastic coin envelopes. The samples were then tested by trying to break them on a resilient pad (a computer mouse pad) using a 5 inch metal scribe with a 5 mm diameter spherical tip. All of the uncoated samples were broken easily, however, none of the coated samples could be broken. There was some visible damage to the coatings at the impact site but the coatings served to preserve the strength of the glass on impact.

A second test was carried out on the samples using the same equipment. Some of the samples having the 30-3 urethane coated edges (as well as some uncoated samples) were struck two times at the same impact spot with the pendulum at 90 degrees. In all cases, the uncoated samples cracked on the second impact, whereas none of the coated samples cracked. In fact, most times the urethane edge coated samples passed without cracking.

Further testing (for yellowness) was performed on a number of samples, using the known Yellowness Index (ASTM D1925). The testing was performed on samples whereby the substrates 102 were formed using 4 inch×4 inch×0.7 mm thick Eagle XG glass from Corning Incorporated, and 1 mil thick coatings 104 were drawn down on the glass substrates 102. Some of the samples were prepared using the coating compositions from examples 2, 6, 9, and 10 of U.S. Pat. No. 5,648,407, whereby the coatings 104 were cured as specified in U.S. Pat. No. 5,648,407 (namely, 3 hours at 177° C.). Other samples were prepared using further coating compositions, called ECE-1 and ECE-2, which were UV cured at 4 feet/minute under two Fusion Systems 600 W/in lamps (H+ and D) at 100% power (20 J/cm²), and then post baked in an oven for 24 hours at 100° C.

The particular composition for ECE-1, which is an epoxy resin based material, and the particular composition for ECE-2, which is also an epoxy resin based material, are summarized in the two tables presented below (Tables 19 and 20).

TABLE 19
ECE-1 Coating

| Percent by | Ingredient | |
|---|---|---|
| Weight | Trade Name | Ingredient Chemical Type |
| 48.00 | Nanopox C-620 | Cycloaliphatic epoxy resin with 40% |
| | | by weight 20 nm spherical nanosilica |
| 48.00 | Nanopox C-680 | Oxetane monomer with 50% by |
| | | weight 20 nm spherical nanosilica |
| 1.00 | Cyracure UVI-6976 | Cationic Photoinitiator |
| 3.00 | Silquest A-186 | Silane adhesion promoter |

TABLE 20
ECE-2 Coating

| Percent by | Ingredient | |
|---|---|---|
| Weight | Trade Name | Ingredient Chemical Type |
| 47.93 | Nanopox C-620 | Cycloaliphatic epoxy resin with 40% |
| | | by weight 20 nm spherical nanosilica |
| 47.93 | Nanopox C-680 | Oxetane monomer with 50% by |
| | | weight 20 nm spherical nanosilica |
| 1.10 | Cyracure UV-6976 | Cationic Photoinitiator |
| 3.00 | Silquest A-186 | Silane adhesion promoter |
| 0.04 | 50% NaOH | 50% NaOH in H₂O |

The results of the Yellowness Index (ASTM D1925) testing is summarized in the table below (Table 21). The results for the samples having the coating of example 2 of U.S. Pat. No. 5,648,407 exhibited yellowness indices all over 50, with a mean of 59.6. The results for the samples having the coating of example 6 of U.S. Pat. No. 5,648,407 exhibited yellowness indices all over 40, with a mean of 51.88. The results for the samples having the coating of example 9 of U.S. Pat. No. 5,648,407 exhibited yellowness indices all over 48, with a mean of 49.07. The results for the samples having the coating of example 10 of U.S. Pat. No. 5,648,407 exhibited yellowness indices ranging from 1.66 through 2.74, with a mean of 2.18. The results for the samples having the coating of EXE-2 exhibited yellowness indices ranging from 3.69 through 3.86, with a mean of 3.77.

TABLE 21

| Patent | Formulation | Yellowness |
|---|---|---|
| Example | Number | Index |
| 2 | 77-1 | 60.16 |
| | | 57.49 |
| | | 59.97 |
| | | 59.02 |
| | | 61.37 |
| | | mean = 59.60 |
| | | SD = 1.45 |
| 6 | 77-2 | 55.39 |
| | | 40.52 |
| | | 61.41 |
| | | 51.59 |
| | | 50.48 |
| | | mean = 51.88 |
| | | SD = 7.65 |
| 9 | 77-3 | 50.07 |
| | | 49.07 |
| | | 48.37 |
| | | 48.71 |
| | | 49.14 |
| | | mean = 49.07 |
| | | SD = 6.18 |
| 10 | 83-1 | 2.14 |
| | | 2.33 |
| | | 2.74 |
| | | 1.66 |
| | | 2.05 |
| | | mean = 2.18 |
| | | SD = 0.40 |
| ECE-2 | 50-2 | 3.79 |
| | | 3.76 |
| | | 3.69 |
| | | 3.86 |

Further testing (tumble testing) was performed on a number of samples, whereby the substrates 102 were coated with a number of coating compositions, including the ECE-1 coating, the UV22 coating (discussed above), and Delco Katiobond OMVE 112085. A number of samples were also prepared without any coating. The uncoated samples exhibited an average of 8.8 drops (and standard deviation of 3.8). The samples employing the ECE-1 coating exhibited an average of 36.9 drops (and standard deviation of 9.4). The samples employing the UV22 coating exhibited an average of 22.9 drops (and standard deviation of 6.4). The samples employing the Delco Katiobond OMVE 112085 coating exhibited an average of 22.4 drops (and standard deviation of 7.9).

Further testing (indentation fracture testing) was performed on a number of samples, whereby the substrates 102 were coated with a number of different coating compositions, including: no-coating (uncoated substrates), ECE-1, UV22, ES28, 28-i (discussed further below), and other coatings that were developed through experimentation and/or obtained commercially are identified in the results section later herein.

A number of coatings of differing compositions were prepared to evaluate the effect of the quantities of nanometer-sized inorganic particles in the coating on certain performance criteria, including indentation fracture testing. In this regard, the different coatings were named 28-1, 28-2, 28-3, 28-4, and 28-5, where each composition contained a different amount (in weight percent) of nanometer-sized silica particles (of typical size 20 nm). The compositions are summarized in the tables below (Tables 22-26).

TABLE 22
28-1 Coating—total weight percentage of
nano-silica = 0%; and maximum nano-silica loading 0%

| Weight | | | |
|---|---|---|---|
| Percent | Ingredient | Name | Ingredient Chemical Name |
| 48.0 | epoxy | Syna Epxy | cycloaliphatic epoxy resin with |
| | | S-06E | 0% by weight 20 nm nanosilica |
| 48.0 | monomer | Syna OXA | oxetane monomer with 0% by |
| | | S-101 | weight 20 nm nanosilica |
| 3.0 | silane | Silquest | silane adhesion promoter |
| | | A-156 | |
| 1.0 | photoinitiator | Cyracure | cationic photoinitiator |
| | | UVI 6976 | |

TABLE 23
28-2 Coating—total weight percentage of
nano-silica = 10.8%; and maximum nano-silica loading 25%

| Weight | | | |
|---|---|---|---|
| Percent | Ingredient | Name | Ingredient Chemical Name |
| 12.0 | epoxy | Nanopox | cycloaliphatic epoxy resin with |
| | | C-620 | 40% by weight 20 nm |
| | | | nanosilica (actual 4.8 weight %) |
| 36.0 | epoxy | Syna Epxy | cycloaliphatic epoxy resin |
| | | S-06E | |
| 12.0 | monomer | Nanopox | oxetane monomer with 50% by |
| | | C-680 | weight 20 nm nanosilica |
| | | | (actual 6.0 weight %) |
| 36.0 | monomer | Syna OXA | oxetane monomer |
| | | S-101 | |
| 3.0 | silane | Silquest | silane adhesion promoter |
| | | A-156 | |
| 1.0 | photoinitiator | Cyracure | cationic photoinitiator |
| | | UVI 6976 | |

TABLE 24
28-3 Coating—total weight percentage of
nano-silica = 21.6%; and maximum nano-silica loading 50%

| Weight | | | |
|---|---|---|---|
| Percent | Ingredient | Name | Ingredient Chemical Name |
| 24.0 | epoxy | Nanopox | cycloaliphatic epoxy resin |
| | | C-620 | with 40% by weight 20 nm |
| | | | nanosilica (actual 9.6 weight %) |
| 24.0 | epoxy | Syna Epxy | cycloaliphatic epoxy resin |
| | | S-06E | |
| 24.0 | monomer | Nanopox | oxetane monomer with 50% by |
| | | C-680 | weight 20 nm nanosilica |
| | | | (actual 12.0 weight %) |
| 24.0 | monomer | Syna OXA | oxetane monomer |
| | | S-101 | |
| 3.0 | silane | Silquest | silane adhesion promoter |
| | | A-156 | |
| 1.0 | photoinitiator | Cyracure | cationic photoinitiator |
| | | UVI 6976 | |

TABLE 25
28-4 Coating—total weight percentage of
nano-silica = 32.4%; and maximum nano-silica loading 75%

| Weight | | | |
|---|---|---|---|
| Percent | Ingredient | Name | Ingredient Chemical Name |
| 36.0 | epoxy | Nanopox | cycloaliphatic epoxy resin |
| | | C-620 | with 40% by weight 20 nm |
| | | | nanosilica (actual 14.4 weight %) |
| 12.0 | epoxy | Syna Epxy | cycloaliphatic epoxy resin |
| | | S-06E | |
| 36.0 | monomer | Nanopox | oxetane monomer with 50% |
| | | C-680 | by weight 20 nm nanosilica |
| | | | (actual 18.0 weight %) |
| 12.0 | monomer | Syna OXA | oxetane monomer |
| | | S-101 | |
| 3.0 | silane | Silquest | silane adhesion promoter |
| | | A-156 | |
| 1.0 | photoinitiator | Cyracure | cationic photoinitiator |
| | | UVI 6976 | |

TABLE 26
28-5 Coating—total weight percentage of
nano-silica = 43.2%; and maximum nano-silica loading 100%

| Weight | | | |
|---|---|---|---|
| Percent | Ingredient | Name | Ingredient Chemical Name |
| 48.0 | epoxy | Nanopox | cycloaliphatic epoxy resin with |
| | | C-620 | 40% by weight 20 nm nanosilica |
| | | | (actual 19.2 weight %) |
| 48.0 | monomer | Nanopox | oxetane monomer with 50% |
| | | C-680 | by weight 20 nm nanosilica |
| | | | (actual 24.0 weight %) |
| 3.0 | silane | Silquest | silane adhesion promoter |
| | | A-156 | |
| 1.0 | photoinitiator | Cyracure | cationic photoinitiator |
| | | UVI 6976 | |

The respective samples having UV curable coatings were prepared on 2 inch×2 inch×0.7 mm glass substrates 102. The substrates 102 were cleaned for ten minutes in a UV ozone cleaner, and then the coating material was applied using a CEE spin coater. The spin rate for a material was dependent on the desired thickness and viscosity of the coating material. If the coating material had a viscosity that was too high to spin coat to a desired thickness, the coating was heated in an oven and the glass substrate and spin coat chuck were heated using a hot air gun prior to spin coating. The standard rate and time for the ECE-1 coating to achieve a 20-30 micron thick coating layer was 2000 rpm for 30 seconds at a ramp rate of 1000 rps at room temperature. Once the coatings were applied, they were cured using a dual 600 W Fusion UV conveyor at 20 J/cm² with a 4 feet/minute belt speed. The samples were post cured for 16 hours in a 100° C. oven. The thickness of coatings on the samples was determined using a Dectak profilometer.

The respective samples having thermally curable coatings were prepared on 2 inch×2 inch×0.7 mm glass substrates 102. The substrates 102 were cleaned for ten minutes in a UV ozone cleaner, and then the coating material was applied using a CEE spin coater. The spin rate for a material was dependent on the desired thickness and viscosity of the coating material. The samples having the 3M coatings were prepared using a solvent thinned version of example 10 composition from U.S. Pat. No. 5,648,407. Five grams of the example 10 composition was dissolved in 4 g cyclohexanone, 1 g mesitylene, 1 g dimethylformamide, and then the solvent was evaporated to achieve required viscosity to get a desired coating thickness via spin coating. The coated samples was left at room temperature for 16 hours to evaporate the remaining solvent, and then cured at 177° C. for 3 hours. The thickness of coatings on the samples was determined using a Dectak profilometer.

The testing protocol for the samples included some machine preparation, including: (i) the Bluehill software test method (Ito modified); (ii) calibrating the load cell then balance load; (iii) cleaning tip with IPA and q-tip; and (iv) cleaning Pyrex plate with IPA and clean room wipe. The testing protocol for the samples also included some sample preparation, including: (i) cleaning sample with IPA and clean room wipe (both sides) and let dry; (ii) marking 5 dots equally spaced by eye in the upper right hand quadrant of the sample with a blue Sharpie; (iii) taping sample to Pyrex plate on the upper left hand and lower right hand corners with masking tape.

The pre-test protocols included: (i) finding and adjusting the focus on the left blue dot; (ii) moving the X-Y stage to position the indenter tip above the blue dot; (iii) bringing the indenter tip in contact with the surface; (iv) using the hand wheel to bring the tip up 3 to 4 positions and reset gauge length; and (v) moving the X-Y stage to lower side of blue dot to begin indentation testing.

The test protocols included: (i) performing 5-10 indents vertically at a specified load with adequate spacing (about 1 mm); (ii) for IX Gorilla™ glass, starting at 3000 g and increasing the load by 500 g, performing 5 more indents with the same spacing, repeating until cracks (popin) reported, and count number of cracks; (iii) for Non-IX Gorilla™ glass or display glass (e.g., Eagle XG), starting at 100 g and increasing the load by 100 g, performing 10 more indents with the same spacing, repeating until cracks (popin) reported, and count number of cracks; (iv) for Non-IX Godzilla glass, starting at 15000 g and increasing load by 5000 g up to 30000 g, performing 5 more indents with the same spacing, repeating until the glass fails; (v) for coated glass start at 5000 g and increasing the load by 5000 g, performing 10 more indents with the same spacing, repeating until crack popin, and if cracks popin at 5000 g stop test and consult; (vi) during the unloading cycle make observations if cracking is occurring by recording the number of radial cracks out of 4 possible from each corner of the Vickers indent; (vii) cleaning tip after each load with q-tip; (viii) setting samples aside in safe location in a humidity and temperature controlled room for 24 hours; (ix) making observations of delayed crack pop-in using the same method of counting the number of cracks possible out of 4; and (x) if samples fail, removing and cleaning Pyrex plate of debris.

Post-test protocols included: (i) data interpretation, such as looking over indentation loads and cracking behavior and time to crack pop-in after indentation; and (ii) preparing summary tables with explanation of chosen loads.

The results of the indentation fracture resistance test on the samples are summarized in the tables below (Tables 27-29).

TABLE 27

| | | | | | Coating | Load |
|---|---|---|---|---|---|---|
| | | | | | thickness | indenter |
| | | initial | Next Day | | measured | touches |
| | | response | results | IFT | Dektak | glass |
| Coating type | Glass type | @ IFT | @ IFT | kgf | [symbol] | @ kgf |
| ECE-1 on | | | | | | |
| different glasses | | | | | | |
| bare glass | Bare glass | 6/10 | 10/10 | | | |
| bare glass | 883 FET Bare | 5/10 | 9/10 | 0.4 | | |
| bare glass | 2318 Non-IOX Bare | 9/10 | 9/10 | 0.3 | | |
| bare glass | AN 100 | 0/10 | 7/10 | 0.1 | | |
| bare glass | 882 FES | 6/10 | 9/10 | 0.6 | | |
| bare glass | OIAO NEG | 3/10 | 6/10 | 0.6 | | |
| bare glass | 0211Bare | 4/10 | 8/10 | 0.1 | | |
| bare glass | HPFS Bare | 8/10 | 8/10 | 0.2 | | |
| bare glass | Pyrex 7740 | 7/10 | 9/10 | 0.4 | | |
| bare glass | CS 77 | 10/10 | 10/10 | 0.1 | | |
| bare glass | Keralite cerammed | 10/10 | 10/10 | 0.1 | | |
| bare glass | 9664 cerammed | 0/10 | 5/10 | 0.1 | | |
| bare glass | Keralite uncerammed | 3/10 | 5/10 | 0.5 | | |
| bare glass | 1737 | 3/10 | 8/10 | 1.2 | | |
| bare glass | Eagle XG | 10/10 | | 2.0 | | |
| bare glass | Lotus | 5/5 | | 0.3 | | |
| bare glass | Soda lime silicate | 5/5 | | 0.3 | | |
| bare glass | IOX Soda lime silicate | 5/5 | | 0.5 | | |
| ECE-1 first spin | | | | | | |
| ECE-1 | 883 FET Coated | 5/5 | 5/5 | 5. | | 1.2 |
| ECE-1 | 2318 Non-IOX Coated | 5/5 | 5/5 | 10.0 | | 1.2 |
| ECE-1 | AN 100 Coated | 7/10 | 10/10 | 10.0 | | 1 |
| ECE-1 | 882 FES Coated | 6/10 | 9/10 | 5. | | 1.2 |
| ECE-1 | OIAO NEG Coated | 5/10 | 10/10 | 17.5 | | 1.2 |
| ECE-1 | 0211 coated | 5/10 | 8/10 | 12.5 | | 1 |
| ECE-1 | HPFS Coated | 10/10 | 10/10 | 5. | | 1 |
| ECE-1 | Pyrex 7740 | 6/10 | 8/10 | 5. | | 1 |
| ECE-1 | CS 77 | 6/10 | 10/10 | 2. | | 1 |
| ECE-1 | Keralite Cerammed | 7/10 | 10/10 | 2. | | 1.1 |
| ECE-1 | 9664 cerammed | | | | | |
| ECE-1 | Keralite uncerammed | 8/10 | 10/10 | 5. | | 1.1 |
| ECE-1 | 1737 | | | | | |
| ECE-1 | Eagle XG | 10/10 | 10/10 | 15.0 | | 1.1 |
| ECE-1 | Lotus | 5/10 | 10/10 | 12.5 | | 1 |
| ECE-1 2nd | | | | | | |
| spin samples | | | | | | |
| ECE-1 | 883 FET Coated | 10/10 | | 5. | | 2.0 |
| ECE-1 | 2318 Non- IOX Coated | 0/10 | 0/10 | 20.0 | 22.0 | 2.0 |
| ECE-1 | AN 100 Coated | 6/10 | | 12.5 | | 1.9 |
| ECE-1 | 882 FES Coated | 10/10 | | 5. | | 2.0 |
| ECE-1 | OIAO NEG Coated | | | | | |
| ECE-1 | 0211 coated | 5/10 | | 12.5 | 23.0 | 2 |
| ECE-1 | HPFS Coated | 10/10 | | 5. | | 2 |
| ECE-1 | Pyrex 7740 | 6/10 | | 7. | | 2.1 |
| ECE-1 | CS 77 | 10/10 | | 2. | | 2 |
| ECE-1 | Keralite Cerammed | | | | | |
| ECE-1 | 9664 cerammed | | | | | |
| ECE-1 | Keralite uncerammed | 7/10 | | 7. | | 2.4 |
| ECE-1 | 1737 | | | | | |
| ECE-1 | Eagle XG | 0/10 | 3/10 | 30.0 | | 2.1 |
| ECE-1 | Lotus | 5/5 | | 15.0 | | 2.1 |

| | | |
|---|---|---|
| ECE-1 | Soda lime silicate 5/5 | 5.0 |

[symbol]

indicates data missing or illegible when filed

TABLE 28

| | | | | | Coating | Load |
|---|---|---|---|---|---|---|
| | | | | | thickness | indenter |
| | | initial | Next Day | | measured | touches |
| | | response | results | IFT | Dektak | glass |
| Coating type | Glass type | @ IFT | @ IFT | kgf | microns | @ kgf |
| ECE-1 | IOX Soda lime silicate 5/5 | | | | 5.0 | |
| ECE-1-3rd spin coat | Eagle XG | 4/5 | 5/5 | 30.0 | | 1.2 |
| 3m like coatings | | | | | | |
| 16646-77-1 draw down | Eagle XG | 5/5 | | 30.0 | 57.2 | 6.2 |
| 16646-77-2 draw down | Eagle XG | 5/5 | | 10.0 | 38.0 | 1.6 |
| 16646-77-3 draw down | Eagle XG | 5/5 | | 20.0 | 40.0 | 3.1 |
| ECE-2 draw down | Eagle XG | 5/5 | | 25.0 | 30.0 | 2.4 |
| 83-1 | Eagle XG | 5/5 | | 20.0 | 57.7 | >20 |
| 86-1 | Eagle XG | 5/5 | | 20.0 | 33.5 | 5.8 |
| Epoxy/Urethane study | | | | | | |
| 42-1 spin coat | Eagle XG | 8/10 | 10/10 | 25.0 | 23.5 | 1.3 |
| 41-2 spin coat | Eagle XG | 10/10 | | 30.0 | 25.3 | 2.7 |
| 41-3 spin coat | Eagle XG | 10/10 | | 30.0 | ? | 2.3 |
| 41-4 spin coat | Eagle XG | 9/10 | 10/10 | 30.0 | 18.7 | 2.7 |
| 41-5 spin coat | Eagle XG | 6/10 | | 25.0 | 17.4 | 2.6 |
| 147-1 | Eagle XG | 5/5 | | 30.0 | 23.2 | 2 |
| 147-2 | Eagle XG | 5/5 | | 30.0 | 22.3 | 1.5 |
| 148-1 | Eagle XG | 1/5 | 5/5 | >30 | 24.3 | 1.5 |
| 113-1 | Eagle XG | 5/5 | | 25.0 | 21.4 | 1.1 |
| 113-2 | Eagle XG | 5/5 | | 30.0 | 22.8 | 1.1 |
| Master Bond | | | | | | |
| ES28LV 1500 RPM | Eagle XG | 0/5 | 5/5 | >30 | | |
| ES28LV 2000 RPM | Eagle XG | 5/10 | 10/10 | 25.0 | | |
| ES28LV 2500 RPM | Eagle XG | 6/10 | 10/10 | 25.0 | | |
| Urethane coatings | | | | | | |
| 16046-149-2 draw down | Eagle XG | 9/10 | 10/10 | 15.0 | | 1.9 |
| 16646-7-1 draw down | Eagle XG | 9/10 | 10/10 | 20.0 | | 5 |
| 16646-6-2 spin coat | Eagle XG | 8/10 | 10/10 | 25.0 | | 2.9 |
| 16646-7-2 draw down | Eagle XG | 7/10 | 10/10 | 10.0 | | 2.8 |
| 16646-10-1 draw down | Eagle XG | 10/10 | | 25.0 | | 3 |
| 16646-10-2 draw down | Eagle XG | 8/10 | 10/10 | 10.0 | | 1 |
| Silica loading | | | | | | |
| bare glass | Eagle XG | | | 2. | 0.0 | |
| 28-1 500 | Eagle XG | 5/5 | | 5. | 22.8 | 1.7 |
| 28-2 800 | Eagle XG | 5/5 | | 5. | 16.2 | 0.8 |
| 28-3 800 | Eagle XG | 5/5 | | 20.0 | 20.9 | 1.3 |
| 28-4 1000 | Eagle XG | 5/5 | | 25.0 | 23.4 | 1.4 |
| 28-5 1500 (ECE-1) | Eagle XG | | | 40.0 | 27.4 | 2 |
| 25 and 50 micron study | | | | | | |
| ECE-1 | Eagle XG | 5/5 | | <20 | 26.0 | 2.4 |
| ECE-2 | Eagle XG | 5/5 | | 35.0 | 23.7 | 1.9 |
| UV22 | Eagle XG | 5/5 | | 15.0 | 29.7 | 3 |
| ES28 | Eagle XG | 5/5 | | 30.0 | 22.4 | 2.1 |
| 83-1 | Eagle XG | 5/5 | | 15.0 | 21.0 | 1.5 |

TABLE 29

| | | | | | Coating | Load |
|---|---|---|---|---|---|---|
| | | | | | thickness | indenter |
| | | initial | Next Day | | measured | touches |
| | | response | results | IFT | Dektak | glass |
| Coating type | Glass type | @ IFT | @ IFT | kgf | microns | @ kgf |
| ECE-1 | Eagle XG | 4/5 | 5/5 | 50.0 | 50.2 | 5.9 |
| ECE-2 | Eagle XG | 10/10 | | 35.0 | 48.4 | 7.2 |
| UV22 | Eagle XG | 5/5 | | 35.0 | 46.4 | 5.2 |
| ES28 | Eagle XG | 5/5 | | 35.0 | 51.0 | 7.5 |
| 83-1 | Eagle XG | 5/5 | | 25.0 | 46.4 | 4.2 |
| Thickness | | | | | | |
| experiment-ECE- | | | | | | |
| 750 RPM | Eagle XG | 0/5 | 0/5 | >30 | 42.8 | 3.7 |
| 1000 RPM | Eagle XG | 1/10 | 1/10 | >30 | 29.8 | 2.4 |
| 1200 RPM | Eagle XG | 5/5 | | 30.0 | 24.5 | 1.6 |
| 2000 RPM | Eagle XG | 6/10 | 9/10 | 25.0 | 18.9 | 0.8 |
| 2500 RPM | Eagle XG | 5/10 | 10/10 | 20.0 | 10.0 | 0.4 |
| 4500 RPM | Eagle XG | 9/10 | | 10.0 | 5.9 | 0.1 |
| Particle size experiment | | | | | | |
| 16046-140-1 draw down | Eagle XG | 5/10 | 8/10 | 20.0 | | 1.5 |
| 16046-141-1 draw down | Eagle XG | 5/5 | | 25.0 | | 1.3 |
| 16046-141-2 draw down | Eagle XG | 5/5 | | 20.0 | | 0.5-1.1 |
| Willow glass | | | | | | |
| bare | Eagle XG | 8/10 | | 1. | | |
| with ECE-1 | Eagle XG | 6/10 | | 10.0 | | |
| Silica loading on iox 2318 | | | | | | |
| bare glass | 2318 | | | 7. | 0.0 | |
| 28-1 | 2318 | 0/5 | | >45 | 23.9 | 2.2 |
| 28-2 | 2318 | 0/5 | | >50 | 22.3 | 2 |
| 28-3 | 2318 | 0/5 | | >50 | 24.1 | 1.8 |
| 28-4 | 2318 | 0/5 | | >50 | 23.0 | 2.1 |
| 28-5 (ECE-1) | 2318 | 0/5 | | >50 | 30.3 | 2.8 |
| ECE-1 free film | | | | | | |
| bare EXG | Eagle EXG | | | 2. | | |
| ECE-1 film | Eagle EXG | | | 15.0 | (25) | 1.2 |
| Silica loading on non iox | | | | | | |
| 28-1 | non iox 2318 | 9/10 | | 7. | | 1.8 |
| 28-5 (ECE-1) | non iox 2318 | 5/5 | | 30.0 | | 2.3 |
| no coating | non iox 2318 | | | 0. | | |
| Nano particles | | | | | | |
| 118-1 surface treated | Eagle EXG | | | 30.0 | | 2.9 |
| 118-2 surface treated with | Eagle EXG | | | 30.0 | | 0.5 |
| non functional | | | | | | |
| IOX 2318 on 50 micron | | | | | | |
| ECE-1 | iox 2318 | 5/5 | | 70.0 | | 8 |
| UV22 | iox 2318 | 5/5 | | >70 | | 5.9 |
| DSM | iox 2318 | 5/5 | | 70.0 | | 1 |
| 28-5 (ECE-1) | iox 2318 | 5/5 | | >70 | | 9.5 |
| IOX 2318 at 28.4 micron | | | | | | |
| UV22 | iox2318 | 5/5 | | >70 | | |
| Non IOX 2318 at 50 micron | | | | | | |
| ECE-1 | non ix 2318 | 5/5 | | 40.0 | | 7.3 |
| 28-5 | non ix 2318 | 5/5 | | 40.0 | | 8.2 |
| 3M | non ix 2318 | 5/5 | | 20.0 | | 3.4 |
| ***UV22 | non ix 2318 | | | 70.0 | | |
| Non IOX 2318 at 25 micron | | | | | | |
| 3M | non ix 2318 | 5/5 | | 10.0 | | 1.9 |
| UV22 | non ix 2318 | 5/5 | | 30.0 | | 2.4 |

Conclusions drawn from at least some of the above experimentation is set forth below.

The impact resistance of Non-IX Gorilla™ glass is improved by greater than 8 times as measured by the sliding drop test. The impact resistance of IX Gorilla™ glass with the same edge coating is increased by 2.7 times over uncoated IX Gorilla™ glass.

Indentation fracture resistance where the edge of the glass is indented using a Vickers hardness test is improved for Non-IX Gorilla™ glass from 2-300 g load for uncoated glass to greater than 2000 g load for polymer edge coated glass.

The 4 point bend strength of Gorilla™ glass for polymer edge coated Bettie 5000 edge impacted samples was about the same as non-impacted Gorilla™ glass (provided three layers of coating material was applied).

Tumble testing for full Gorilla™ glass was increased from less than 10 drops for uncoated samples to greater than 300 drops for coated edge samples. Edge coated samples of IX Gorilla™ glass (with Non-IX edges) were improved by four times for an epoxy based edge coating and ten times for a urethane based edge coating.

The static indentation fracture resistance was measured on the 71-3 epoxy composition coated 25 μm thick over IX Gorilla™ glass as well as Eagle XG glass. The results were as follows: (i) IX glass indentation fracture without coating was about 6-7 kilograms force (typical of IX glass); (ii) IX glass indentation fracture with coating was greater than 30 kgf (which was the limit of the test capabilities); (iii) Eagle XG glass indentation fracture without coating was about kgf (which was typical of XG glass); (iv) Eagle XG glass indentation fracture with coating was about 17-20 kgf. These results show the outstanding ability of the 71-3 coating composition to protect both Eagle XG as well as IX Gorilla™ glass from fracture by indentation with a diamond tip indenter. There was a 50% increase in retained strength of edge coated 0.7 mm thick CT52 IX Gorilla™ glass (with Non-IX edges) samples after abrasion with 90 grit SiC at 5 psi versus non edge coated samples.

Other suitable compositions for the coating 104 are provided in Tables 30 and 31.

TABLE 30
Composition ECE-3.

| Percent by | Ingredient | |
|---|---|---|
| Weight | Trade Name | Ingredient Chemical Type |
| 70.69 | Nanopox C-620 | Cycloaliphatic epoxy resin |
| | | with 40% by weight 20 nm |
| | | spherical nanosilica |
| 23.56 | Nanopox C-680 | Oxetane monomer with |
| | | 50% by weight 20 nm |
| | | spherical nanosilica |
| 3.00 | Coatosil MP-200 | Silane adhesion promoter |
| 2.50 | Cyracure UVI-6976 | Cationic photoinitiator |
| 0.25 | Tinuvin 292 | Hindered amine light |
| | | stabilizer |

TABLE 31
Composition 76-5.

| Percent | | | |
|---|---|---|---|
| by | | | |
| Weight | | Ingredient | |
| (%) | Ingredient | Trade Name | Ingredient Chemical Name |
| 41.125 | Oligomer | CN9009 | Aliphatic urethane acrylate |
| | | | oligomer |
| 5.875 | Oligomer | Ebecryl | 40% by weight 20 nm |
| | | 8311 | nanosilica dispersed in |
| | | | aliphatic urethane acrylate |
| 47.000 | Monomer | NK Ester | 2-Acryloxyethyl hydrogen |
| | | A-SA | succinate |
| 3.000 | Photoinitiator | Darocur | 2-Hydroxy-2-methyl-1- |
| | | 1173 | phenyl-propan-1-one |
| 3.000 | Silane Adhesion | APTMS | 3- |
| | Promoter | | Acryloxypropyltrimethoxysilane |

Glass samples coated with Composition 76-5, using methods described herein, were subjected to tumble drop testing. In such testing, the samples passed an average of about 200 drops.

Although the disclosure herein has been described with reference to particular embodiments, it is to be understood that these embodiments are merely illustrative of the principles and applications of the embodiments herein. It is therefore to be understood that numerous modifications may be made to the illustrative embodiments and that other arrangements may be devised without departing from the spirit and scope of the present application.

1. An apparatus, comprising:
a glass substrate having first and second opposing surfaces, and a plurality of edge surfaces extending transversely between the first and second opposing surfaces;
a layer disposed on, and adhered to, at least one of the first, second, and edge surfaces of the substrate,
wherein the layer includes: (i) one of an oligomer and resin; (ii) a monomer; and (iii) nanometer-sized silica particles of at least about 2-50 weight percent.

2. The apparatus of claim 1, wherein the weight percentage of the nanometer-sized silica particles is one of: (i) between about 10-30 weight percent; (ii) between about 10-20 weight percent; (iii) between about 10-15 weight percent; and (iv) at least about 14 weight percent.

3. The apparatus of claim 1, wherein at least 70-90 percent of the nano-sized silica particles have diameters of one of: (i) between about 5-40 nm; (ii) between about 7-35 nm; (iii) between about 10-30 nm; (iv) between about 15-25 nm; (v) between about 17-23 nm; and (vi) about 20 nm.

4. The apparatus of claim 1, wherein the oligomer is a urethane acrylate of one of: (i) between about 40-60 weight percent; and (ii) about 50 weight percent.

5. The apparatus of claim 1, wherein the oligomer is an aliphatic urethane acrylate, and the monomer is at least one of diethylacrylamide and cyclic trimethylolpropane formal acrylate.

6. The apparatus of claim 1, wherein the resin is an epoxy resin of one of: (i) between about 20-90 weight percent; (ii) between about 25-85 weight percent; (iii) between about 30-80 weight percent; (iv) between about 40-60 weight percent; and (v) about 50 weight percent.

7. The apparatus of claim 1, wherein the resin is a cycloaliphatic epoxy resin and the monomer is an oxetane monomer.

8. The apparatus of claim 1, wherein the monomer is one of: (i) between about 2-60 weight percent; (ii) between about 3-50 weight percent; (iii) between about 5-40 weight percent; (iv) between about 40-60 weight percent; and (v) about 40-50 weight percent.

9. The apparatus of claim 1, wherein the layer is formed from an ultra-violet curable composition.

10. The apparatus of claim 1, wherein the layer has a thickness of one of: (i) between about 10-100 microns; (ii) between about 20-80 microns; (iii) between about 20-50 microns; and (iv) between about 20-30 microns.

11. The apparatus of claim 1, wherein the glass substrate is of an alkali-free glass composition.

12. The apparatus of claim 1, wherein the glass substrate is of an alkaline earth boroaluminosilicate composition.

13. The apparatus of claim 1, wherein the glass substrate composition is as follows: 65%≦SiO₂≦75%; 5%≦B₂O₂≦15%; 7%≦Al₂O₃≦13%; 5%≦CaO≦15%; 0%≦BaO≦5%; 0%≦MgO≦3%; and 0%≦SrO 5%.

14. The apparatus of claim 1, wherein:
the glass substrate exhibits an initial indentation fracture threshold, without the layer disposed on, and adhered to, the at least one of the first, second, and edge surfaces thereof;
the glass substrate, with the layer disposed on, and adhered to, the at least one of the first, second, and edge surfaces thereof, exhibits a final indentation fracture threshold; and
the final indentation fracture threshold is at least about an order of magnitude greater than the initial indentation fracture threshold.

15. The apparatus of claim 1, wherein the layer has a yellowness one of: (i) below about 10.00 ASTM D1925 index; (ii) below about 5.00 ASTM D1925 index; (iii) and below about 4.00 ASTM D1925 index.

16. The apparatus of claim 1, wherein the layer is substantially transparent.

17. A method, comprising:
providing a glass substrate having first and second opposing surfaces, and a plurality of edge surfaces extending transversely between the first and second opposing surfaces;
disposing a liquid coating on at least one of the first, second, and edge surfaces of the substrate, wherein the liquid includes: (i) one of an oligomer and resin; (ii) a monomer; and (iii) nanometer-sized silica particles of at least about 2-50 weight percent; and
curing the liquid to form a layer adhered to the glass substrate.

18. The method of claim 17, wherein the weight percentage of the nanometer-sized silica particles is one of: (i) between about 10-30 weight percent; (ii) between about 10-20 weight percent; (iii) between about 10-15 weight percent; and (iv) at least about 14 weight percent.

19. The method of claim 17, wherein at least 70-90 percent of the nano-sized silica particles have diameters of one of: (i) between about 5-40 nm; (ii) between about 7-35 nm; (iii) between about 10-30 nm; (iv) between about 15-25 nm; (v) between about 17-23 nm; and (vi) about 20 nm.

20. The method of claim 17, wherein the oligomer is a urethane acrylate of one of: (i) between about 40-60 weight percent; and (ii) about 50 weight percent.

21. The method of claim 17, wherein the oligomer is an aliphatic urethane acrylate, and the monomer is at least one of diethylacrylamide and cyclic trimethylolpropane formal acrylate.

22. The method of claim 17, wherein the resin is an epoxy resin of one of: (i) between about 20-90 weight percent; (ii) between about 25-85 weight percent; (iii) between about 30-80 weight percent; (iv) between about 40-60 weight percent; and (v) about 50 weight percent.

23. The method of claim 17, wherein the resin is a cycloaliphatic epoxy resin and the monomer is an oxetane monomer.

24. The method of claim 17, wherein the monomer is one of: (i) between about 2-60 weight percent; (ii) between about 3-50 weight percent; (iii) between about 5-40 weight percent; (iv) between about 40-60 weight percent; and (v) about 40-50 weight percent.

25. The method of claim 17, wherein liquid coating is formed from an ultra-violet curable composition.

26. The method of claim 17, wherein the step of curing the liquid coating comprises applying ultra-violet light to the liquid coating.

27. The method of claim 17, wherein the step of curing the liquid coating comprises applying infra-red light to the liquid coating.

28. The method of claim 17, wherein the layer has a thickness of one of: (i) between about 10-100 microns; (ii) between about 20-80 microns; (iii) between about 20-50 microns; and (iv) between about 20-30 microns.

29. The method of claim 17, wherein the glass substrate is of an alkali-free glass composition.

30. The method of claim 17, wherein the glass substrate is of an alkaline earth boroaluminosilicate composition.

31. The method of claim 17, wherein the glass substrate composition is as follows: 65%≦SiO₂≦75%; 5%≦B₂O₃≦15%; 7%≦Al₂O₃≦13%; 5%≦CaO≦15%; 0%≦BaO≦5%; 0%≦MgO≦3%; and 0%≦SrO≦5%.

32. The method of claim 17, wherein:
the glass substrate exhibits an initial indentation fracture threshold, without the layer disposed on, and adhered to, the at least one of the first, second, and edge surfaces thereof;
the glass substrate, with the layer disposed on, and adhered to, the at least one of the first, second, and edge surfaces thereof, exhibits a final indentation fracture threshold; and
the final indentation fracture threshold is at least about an order of magnitude greater than the initial indentation fracture threshold.

33. The method of claim 17, further comprising at least one of:
(a) applying a silane coupling agent to the at least one of the first, second, and edge surfaces of the substrate prior to disposing the liquid coating thereon;
(b) including a silane coupling agent within the liquid coating; and
(c) both (a) and (b).

34. The method of claim 33, wherein the silane coupling agent is one or more of:
3-amino-propyl triethoxy silane;
3-amino-propyl trimethoxy silane;
amino-phenyl trimethoxy silane;
3-amino-propyl tris(methoxyethoxy ethoxy)silane;
3-(m-amino-phenoxy) propyl trimethoxy silane;
3-amino-propyl methyldiethoxy silane;
n-(2-aminoethyl)-3-aminopropyltri-methoxysilane n-[3-(trimethoxysilyl)propyl]ethylenediamine damo silane;
n-(2-aminoethyl)-3-aminopropyltri ethoxy silane;
n-(6-aminohexyl)aminomethyl-trimethoxy silane;
n-(2-aminoethyl)-11-aminoundecyl-trimethoxy silane;
(aminoethylaminomethyl)phenethyl-trimethoxy silane;
n-3-[(amino(polypropylenoxy)]aminopropyltrimethoxy silane;
(3-trimethoxysilylpropyl)diethylene triamine silane;
(3-trimethoxysilylpropyl)diethylene-triamine silane;
n-phenylaminopropyltrimethoxy silane;
n-phenylaminomethyltriethoxy silane;
bis(trimethoxysilylpropyl)amine silane;
bis[(3-trimethoxysilyl)propyl]-ethylenediamine silane;
bis[3(triethoxysilyl)propyl]urea silane;
ureidopropyltriethoxy silane;
ureidopropyltrimethoxy silane;
2-(3,4-epoxycyclohexyl)ethyltriethoxy silane;
2-(3,4-epoxycyclohexyl)ethyl-trimethoxy silane;
(3-glycidoxypropyl)trimethoxysilane 3-(2,3-epoxypropoxyl) propyltrimethoxy silane;
(3-glycidoxypropyl)triethoxy silane;
5,6-epoxyhexyltriethoxy silane;
3-mercaptopropyltrimethoxy silane; and
3-mercaptopropyltriethoxy-silane.

35. The method of claim 17, further comprising etching at least one of the first, second, and edge surfaces of the substrate prior to applying the liquid coating.
